(19) United States
(12) Patent Application Publication
(10) Pub. No.: US 2025/0317252 A1
(43) Pub. Date: Oct. 9, 2025

(54) METHOD AND APPARATUS FOR SUPPORTING ENERGY SAVINGS IN A WIRELESS COMMUNICATION SYSTEM

(71) Applicant: Samsung Electronics Co., Ltd., Suwon-si, Gyeonggi-do (KR)

(72) Inventors: Cheolkyu SHIN, Suwon-si (KR); Youngbum KIM, Suwon-si (KR); Hyunseok RYU, Suwon-si (KR); Kyoungmin PARK, Suwon-si (KR); Hyewon YANG, Suwon-si (KR)

(21) Appl. No.: 18/861,004

(22) PCT Filed: May 12, 2023
(86) PCT No.: PCT/KR2023/006465

§ 371 Date: Oct. 28, 2024

(30) Foreign Application Priority Data
May 17, 2022 (KR) 10-2022-0060249

(51) Int. Cl. H04L 5/00; H04W 52/02

(52) U.S. Cl. CPC H04L 5/0051; H04W 52/0209

(57) ABSTRACT

The disclosure relates to a 5G or 6G communication system for supporting a higher data transmission rate. Provided, according to various embodiments of the present disclosure, is a method comprising the steps of: receiving, from a base station, first information for dynamically changing the port or beam of a CSI-RS; receiving, from the base station, second information indicating a CSI-RS resource; receiving, on the basis of the first information and the second information, a CSI-RS in the CSI-RS resource; and transmitting, to the base station, CSI comprising measurement results for the CSI-RS.

### TECHNICAL FIELD

The disclosure relates to a wireless (or mobile) communication system and, more particularly, to a method and a device for supporting energy saving in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The disclosure relates to a wireless communication system and, more particularly, to a method and a device for supporting network energy saving in a wireless communication system. Specifically, the disclosure proposes a method wherein, when a gNB adjusts a transmission parameter at a short time interval for the sake of energy saving and cell throughput and coverage management, channel state information (CSI) is measured and reported accordingly.

### Solution to Problem

A method of a terminal according to an embodiment of the disclosure includes: receiving, from a base station, first information for dynamically changing ports or beams of a channel state information reference signal (CSI-RS); receiving, from the base station, second information indicating a CSI-RS resource; receiving a CSI-RS in the CSI-RS resource, based on the first information and the second information; and transmitting, to the base station, channel state information (CSI) including a measurement result regarding the CSI-RS.

A method of a base station according to an embodiment of the disclosure includes: transmitting, to a terminal, first information for dynamically changing ports or beams of a channel state information reference signal (CSI-RS); transmitting, to the terminal, second information indicating a CSI-RS resource; transmitting a CSI-RS in the CSI-RS resource, based on the first information and the second information; and receiving, from the terminal, channel state information (CSI) including a measurement result regarding the CSI-RS.

A terminal according to an embodiment of the disclosure includes: a transceiver; and a controller connected to the transceiver, wherein the controller is configured to: receive, from a base station, first information for dynamically changing ports or beams of a channel state information reference signal (CSI-RS); receive, from the base station, second information indicating a CSI-RS resource; receive a CSI-RS in the CSI-RS resource, based on the first information and the second information; and transmit, to the base station, channel state information (CSI) including a measurement result regarding the CSI-RS.

A method of a base station according to an embodiment of the disclosure includes: a transceiver; and a controller connected to the transceiver, wherein the controller is configured to: transmit, to a terminal, first information for dynamically changing ports or beams of a channel state information reference signal (CSI-RS); transmit, to the terminal, second information indicating a CSI-RS resource; transmit a CSI-RS in the CSI-RS resource, based on the first information and the second information; and receive, from the terminal, channel state information (CSI) including a measurement result regarding the CSI-RS.

### Advantageous Effects of Invention

According to various embodiments proposed in the disclosure, a method for measuring and reporting CSI may be used. Through such embodiments, when a gNB adjusts a transmission parameter at a short time interval for the sake of energy saving and cell throughput and coverage management, measurement and reporting of CSI appropriate therefor may become possible.

### BRIEF DESCRIPTION OF DRAWINGS

FIG. 1 illustrates the basic structure of a time-frequency resource domain of a 5G system according to an embodiment of the disclosure.

FIG. 2 illustrates a beam sweeping operation and a time domain mapping structure of a synchronization signal according to an embodiment of the disclosure.

FIG. 3 illustrates a random access procedure according to an embodiment of the disclosure.

FIG. 4 illustrates a procedure according to an embodiment of the disclosure in which a UE reports UE capability information to a gNB.

FIG. 5 illustrates the correlation between the frequency band, coverage, and bandwidth according to an embodiment of the disclosure.

FIG. 6 illustrates a gNB disposition scenario according to an embodiment of the disclosure.

FIG. 7 illustrates a gNB disposition scenario according to an embodiment of the disclosure.

FIG. 8 illustrates the correlation between downlink signal transmission power configurations according to an embodiment of the disclosure.

FIG. 9 illustrates CSI measurement and CSI reporting by a UE according to an embodiment of the disclosure.

FIG. 10 illustrates a timepoint at which an indication through a MAC-CE is enabled.

FIG. 11A illustrates a method wherein, when a gNB indicates MR, transmission of at least one CSI-reference signal (RS) for channel and interference measurement is provided after corresponding indication is enabled, and prior to a CSI reference resource, according to an embodiment of the disclosure.

FIG. 11B illustrates a method wherein, when a gNB indicates MR, transmission of at least one CSI-reference signal (RS) for channel and interference measurement is provided after corresponding indication is enabled, and prior to a CSI reference resource, according to an embodiment of the disclosure.

FIG. 12 illustrates a case in which MR indication through a medium access control (MAC) control element (CE) or downlink control information (DCI) is allowed only if measurement restriction (MR) is enabled by radio resource control (RRC) according to an embodiment of the disclosure.

FIG. 13 illustrates a case in which MR indication through a MAC CE or DCI is allowed regardless or whether MR is enabled by RRC or not according to an embodiment of the disclosure.

FIG. 14 illustrates a UE transmission/reception device in a wireless communication system according to an embodiment of the disclosure.

FIG. 15 illustrates an internal structure of a UE according to an embodiment of the disclosure.

FIG. 16 illustrates an internal structure of a base station according to an embodiment of the disclosure.

### MODE FOR THE INVENTION

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

The following detailed description of embodiments of the disclosure is mainly directed to New RAN (NR) as a radio access network and Packet Core (5G system or 5G core network or next generation core (NG Core)) as a core network in the 5G mobile communication standards specified by the 3rd generation partnership project (3GPP) that is a mobile communication standardization group, but based on determinations by those skilled in the art, the main idea of the disclosure may be applied to other communication systems having similar backgrounds through some modifications without significantly departing from the scope of the disclosure.

In the 5G system, a network data collection and analysis function (NWDAF), which is a network function for analyzing and providing data collected in a 5G network, may be defined to support network automation. The NWDAF may collect/store/analyze information from the 5G network and provide the results to unspecified network functions (NFs), and the analysis results may be used independently in each NF.

In the following description, some of terms and names defined in the 3GPP standards (standards for 5G, NR, LTE, or similar systems) may be used for the sake of descriptive convenience. However, the disclosure is not limited by these terms and names, and may be applied in the same way to systems that conform other standards.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used herein, and other terms referring to subjects having equivalent technical meanings may be used.

To meet the demand for wireless data traffic having increased since deployment of 4G communication systems, efforts have been made to develop an improved 5G communication system (new radio (NR)). The 5G communication system has been designed to support ultrahigh frequency (mmWave) bands (e.g., 28 GHz frequency bands) so as to accomplish higher data rates. To decrease propagation loss of the radio waves and increase the transmission distance of radio waves in the ultrahigh frequency bands, beamforming, massive multiple-input multiple-output (massive MIMO), full dimensional MIMO (FD-MIMO), array antenna, analog beam forming, large scale antenna techniques are under discuss ion in the 5G communication systems. Furthermore, unlike in the LTE, in the 5G communication systems, various subcarrier spacings including 15 kHz, such as 30 kHz, 60 kHz, and 120 kHz, are supported, physical control channels use polar coding, and physical data channels use low density parity check (LDPC). In addition, as waveforms for uplink transmission, not only a CP-OFDM but also a DFT-S-OFDM are used. While hybrid ARQ (HARQ) retransmission in units of transport blocks (TBs) are supported in LTE, HARQ retransmission based on a code block group (CBG) including a bundle of a plurality of code blocks (CBs) may be additionally supported in 5G.

In addition, in the 5G communication system, technical development for system network improvement is under way based on evolved small cells, advanced small cells, cloud radio access networks (cloud RANs), ultra-dense networks, device-to-device (D2D) communication, wireless backhaul, moving network, cooperative communication, coordinated multi-points (COMPs), reception-end interference cancellation, and the like.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through a connection with a cloud server, etc. has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have recently been researched. Such an IoT environment may provide intelligent Internet technology (IT) services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply the 5G communication system to IoT networks. For example, technologies, such as a sensor network, machine-to-machine (M2M) communication, and machine type communication (MTC), are implemented by beamforming, MIMO, and array antenna techniques that are 5G communication technologies. Application of a cloud radio access network (cloud RAN) as the above-described big data processing technology may also be considered an example of convergence of the 5G technology with the IoT technology. As described above, a communication system may provide multiple services to a user, and in order to provide these multiple services to a user, there is a need for a method that can provide each service in the same time interval according to the characteristics thereof and a device using the same. Various services to be provided in 5G communication systems are being studied, and one of them is a service that satisfies requirements for low latency and high reliability.

Furthermore, demands for mobile services are explosively increasing, and a location-based service (LBS) led by two requirements including an emergency service and a commercial application is rapidly developing. In particular, in the case of communication using sidelink, an NR sidelink system supports UE-to-UE unicast communication, groupcast (or multicast) communication, and broadcast communication. In addition, unlike LTE sidelink, which aims to transmit and receive basic safety information necessary for road driving of vehicles, the NR sidelink aims to provide more advanced services such as platooning, advanced driving, extended sensors, and remote driving.

Particularly, it has been increasingly important to enable a gNB to quickly change the transmission power of a downlink common signal, thereby increasing the energy saving effect. In general, the transmission power of a downlink common signal (primary synchronization signal (PSS), secondary synchronization signal (SSS), physical broadcast channel (PBCH), CSI-RS, or the like) is maintained as it is, except for a special case, once determined in consideration of the cell coverage or the like in the gNB installation step. However, if energy saving is necessary with regard to the gNB, a method in which the gNB quickly changes the transmission power of the downlink common signal, thereby increasing the energy saving effect, may be considered. As an example of a commercial 5G gNB, the gNB may include 64 transmission antennas in a frequency band of 3.5 GHz and 64 power amplifiers corresponding thereto, and may operate at a bandwidth of 100 MHz. Consequently, the amount of power consumed by the gNB increases in proportion to the output of the power amplifiers and the operating time of the power amplifiers. Compared with LTE gNBs, 5G gNBs are characterized by having larger bandwidths and more transmission antennas because of higher operating frequency bands thereof. Such characteristics have the advantage of higher data rates, but incur the cost of larger amounts of power consumed by the gNBs. Therefore, power consumed by the entire mobile communication network increases in proportion to the number of gNBs constituting the mobile communication network. Accordingly, gNBs may adjust transmission parameters to reduce power consumption. However, power consumed by a gNB may be reduced by adjusting the transmission parameter for energy saving, but the cell throughput and coverage may decrease. As a method for overcoming this, the transmission parameter may be adjusted at a short interval such as a transmission time interval (TTI) and a symbol level, thereby minimizing the decrease in the cell throughput and coverage.

The disclosure proposes a method wherein, when a transmission parameter for gNB energy saving is adjusted at a short time interval as described above, channel state information (hereinafter, referred to as CSI) is measured and reported accordingly. specifically, the disclosure a method for measuring and reporting CSI with regard to a case in which the transmission power of a signal transmitted by a gNB is adjusted and with regard to another case in which beamforming is adjusted. It is to be noted that different restrictions regarding the CSI measurement method may be applied according to the two cases. If the CSI measurement method proposed in the disclosure is applied such a gNB adjusts a transmission parameter at a short interval, CSI measurement and reporting appropriate therefor may become possible.

Embodiments of the disclosure have been proposed to support the above-described scenario and, more particularly, an aspect thereof is to provide a method wherein, when a transmission parameter is adjusted at a short time interval for the sake of gNB energy saving and cell throughput and coverage management, channel state information (CSI) is measured and reported accordingly.

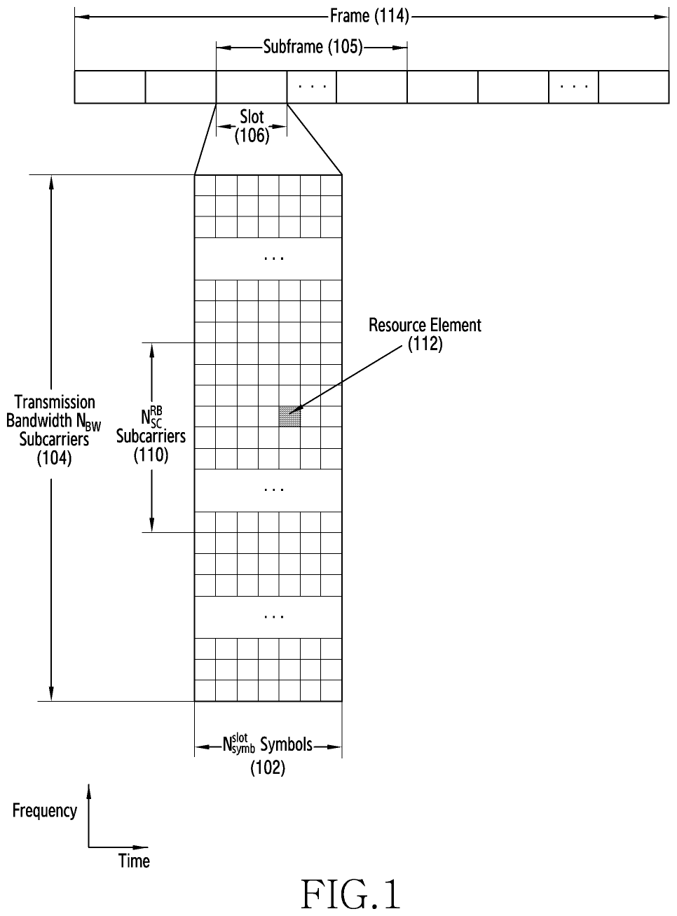

FIG. 1 illustrates the basic structure of a time-frequency resource domain of a 5G system according to an embodiment of the disclosure. That is, FIG. 1 illustrates the basic structure of a time-frequency resource domain which is a radio resource domain used to transmit data or control channels of a 5G system.

Referring to FIG. 1, the horizontal axis in FIG. 1 denotes the time domain, and the vertical axis denotes the frequency domain. The smallest unit of transmission in the time domain of the 5G system is an orthogonal frequency division multiplexing (OFDM) symbol, a group of N_{symb}^{slot} symbols 102 may constitute one slot 106, and a group of Nₛₗₒₜ^{subframe} slots may constitute one subframe 105. One subframe 105 may have a length of 1.0 ms, and a group of ten subframes may constitute a 10 ms frame 114. The smallest unit of transmission in the frequency domain is a subcarrier, and a total of N_{BW} subcarriers 104 may constitute the entire system transmission bandwidth.

The basic unit of resources in the time-frequency domain is a resource element (RE) 112, which may be represented by an OFDM symbol index and a subcarrier index. A resource block (RB) or a physical resource block (PRB) may be defined by N_{sc}^{RB} consecutive subcarriers 110 in the frequency domain. In 5G systems N_{sc}^{RB}=12, and the data rate may increase in proportion to the number of RBs scheduled for the UE.

In a 5G system, the gNB may map data at the RB level, and may generally schedule RBs which constitute one slot with regard to a specific UE. That is, the basic time unit to perform scheduling in 5G systems may be a slot, and the basic frequency unit to perform scheduling may be an RB.

The number N_{symb}^{slot} of OFDM symbols is determined according to the length of a cyclic prefix (CP) which is added to each symbol in order to prevent inter-symbol interference. For example, if a normal CP is applied, N_{symb}^{slot}=14 and, if an extended CP is applied, N_{symb}^{slot}=12. The extended CP is applied to a system having a longer radio-wave transmission distance than the normal CP, thereby maintaining inter-symbol orthogonality. In the case of the normal CP, the ratio between the CP length and the symbol length may be maintained at a constant value such that the overhead due to the CP remains constant regardless of the subcarrier spacing. That is, the symbol length may increase if the subcarrier spacing decreases, thereby increasing the CP length. To the contrary, the symbol length may decrease if the subcarrier spacing increases, thereby decreasing the CP length. The symbol length and the CP length may be inversely proportional to the subcarrier spacing.

In order to satisfy various services and requirements in 5G systems, various frame structures may be supported by adjusting the subcarrier spacing. For example,
From the viewpoint of the operating frequency band, the larger the subcarrier spacing (SCS), the more advantageous to high-frequency-band phase noise restoration.
From the viewpoint of the transmission time, the larger the subcarrier spacing, the smaller the symbol length in the time domain. The resulting smaller slot length makes it more advantageous to support a super-low-latency service such as URLLC.
From the viewpoint of the cell size, the larger the CP length, the larger cell can be supported, meaning that the smaller the subcarrier spacing, the larger cell can be supported. The term “cell” refers to a region covered by one gNB in connection with mobile communication.

The subcarrier spacing, the CP length, and the like are pieces of information indispensable to OFDM transmission/reception, and efficient transmission/reception is possible only if the gNB and the UE recognize the subcarrier spacing, the CP length, and the like as mutually common values. [Table 1] below enumerates the relationship between the subcarrier spacing configuration (μ), the subcarrier spacing (Δf), and the CP length supported in a 5G system.

TABLE 1

| μ | Δf = 2^{μ} · 15 [KHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

Table 2 enumerates the number (N_{symb}^{slot}) of symbols per one slot, the number (Nₛₗₒₜ^{frame,μ}) of slots per one frame, and the number (Nₛₗₒₜ^{subframe,μ}) of slots per one subframe with regard to each subcarrier spacing configuration (μ) in the case of a normal CP.

TABLE 2

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 3 enumerates the number (N_{symb}^{slot}) of symbols per one slot, the number (Nₛₗₒₜ^{frame,μ}) of slots per one frame, and the number (Nₛₗₒₜ^{subframe,μ}) of slots per one subframe with regard to each subcarrier spacing configuration (μ) in the case of an extended CP.

TABLE 3

| μ | N_{symb}^{slot} | Nₛₗₒₜ^{frame, μ} | Nₛₗₒₜ^{subframe, μ} |
|---|---|---|---|
| 2 | 12 | 40 | 4 |

It is expected that 5G systems, in the early state of introduction, will at least coexist with legacy LTE and/or LTE-A (hereinafter, referred to as LTE/LTE-A) systems or operate in a dual mode. Accordingly, legacy LTE/LTE-A may provide UEs with stable system operations, and the 5G systems may play the role of providing UEs with improved services. Therefore, the frame structure of 5G systems needs to at least include the frame structure of LTE/LTE-A or a necessary parameter set (subcarrier spacing=15 kHz).

For example, a comparison between a frame structure having a subcarrier spacing configuration μ=0 (hereinafter, referred to as frame structure A) and a frame structure having a subcarrier spacing configuration μ=1 (hereinafter, referred to as frame structure B) shows that, compared with frame structure A, frame structure B has double the subcarrier spacing and the RB size, and has half the slot length and the symbol length. In the case of frame structure B, two slots may constitute one subframe, and 20 subframes may constitute one frame.

To generalize the frame structure of 5G systems, the subcarrier spacing, the CP length, the slot length, and the like, which constitute a necessary parameter set, of respective frame structures are related so as to correspond to integer multiples with each other, thereby providing a high degree of extendibility. In addition, a subframe having a fixed length of about 1 ms may be defined to express a reference time unit unrelated to the frame structure.

Frame structures of 5G systems may be applied so as to correspond to various scenarios. From the viewpoint of the cell size, the larger the CP length, the larger cells can be supported, meaning that frame structure A may support larger cells than frame structure B. From the viewpoint of the operating frequency band, the larger the subcarrier spacing, the more advantageous to high-frequency-band phase noise restoration, meaning that frame structure B may support a higher operating frequency than frame structure A. From the viewpoint of services, the smaller the slot length (basic time unit of scheduling), the more advantageous to supporting a super-low-latency service such as URLLC, meaning that frame structure B may be more appropriate for an URLLC service than frame structure A.

As used in the following description of the disclosure, the uplink (UL) may refer to a radio link via which a UE transmits data or control signals to a base station, and the downlink (DL) may refer to a radio link via which the base station transmits data or control signals to the UE.

In an initial access step in which a user equipment initially accesses a system, the user equipment may perform downlink time and frequency domain synchronization and acquire a cell identifier (ID) from a synchronization signal, transmitted by a base station, through a cell search. In addition, the UE may receive a PBCH by using the acquired cell ID and acquire a master information block (MIB) as mandatory system information from the PBCH. Additionally, the UE may receive system information (system information block (SIB)) transmitted by the base station to acquire cell-common transmission and reception-related control information. The cell-common transmission and reception-related control information may include random access-related control information, paging-related control information, common control information for various physical channels, etc.

A synchronization signal is a signal that serves as a reference for a cell search, and for each frequency band, a subcarrier spacing may be applied adaptively to a channel environment, such as phase noise. For a data channel or a control channel, in order to support various services as described above, a subcarrier spacing may be applied differently depending on a service type.

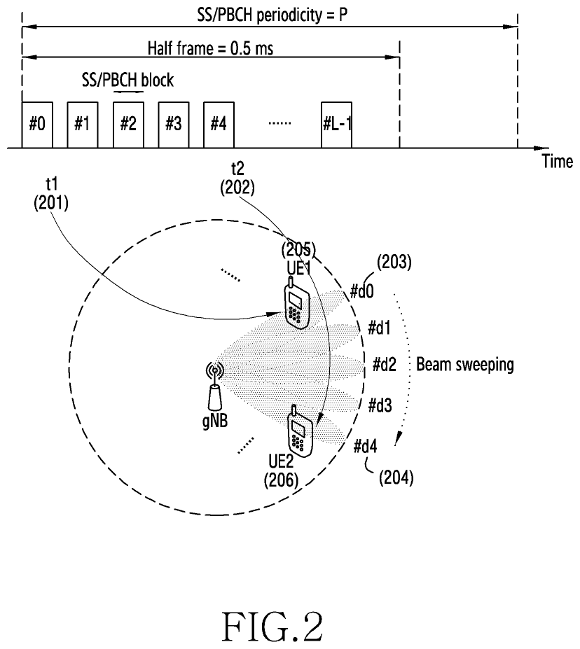

FIG. 2 illustrates a beam sweeping operation and a time domain mapping structure of a synchronization signal according to an embodiment of the disclosure.

For the sake of description, the following elements may be defined.
PSS: A signal which becomes a reference for DL time/frequency synchronization, and provides a part of cell ID information.
SSS: An SSS serves as a reference for DL time/frequency synchronization, and provides the other part of the cell ID information. Additionally, the SSS may serve as a reference signal for PBCH demodulation of a PBCH.
PBCH: provides an MIB which is mandatory system information necessary for the UE to transmit/receive data channels and control channels. The MIB may include search space-related control information indicating radio resource mapping information of a control channel, scheduling control information for a separate data channel for transmission of system information, a system frame number (SFN) which is a frame unit index that serves as a timing reference, and other information.
Synchronization signal/PBCH block (SS/PBCH block or SSB): An SS/PBCH block is configured by N OFDM symbols and may include a combination of a PSS, an SSS, a PBCH, etc. For a system to which a beam sweeping technology is applied, an SS/PBCH block is a minimum unit to which beam sweeping is applied. In the 5G system, N=4 may be satisfied. A base station may transmit up to a maximum of L SS/PBCH blocks, and the L SS/PBCH blocks are mapped within a half frame (0.5 ms). In addition, the L SS/PBCH blocks are periodically repeated at predetermined periods P. The base station may inform a UE of period P via signaling. If there is no separate signaling of period P, the UE may apply a previously agreed default value. Each SS/PBCH block has an SS/PBCH block index ranging from 0 to maximum L−1, and the user equipment may know the SS/PBCH block index through SS/PBCH detection.

Referring to FIG. 2, FIG. 2 illustrates an example in which beam sweeping is applied in units of SS/PBCH blocks over time. In the example of FIG. 2, UE 1 205 receives an SS/PBCH block by means of a beam emitted in direction #d0 203 by beamforming applied to SS/PBCH block #0 at time point t1 201. In addition, UE 2 206 receives an SS/PBCH block by means of a beam emitted in direction #d4 204 by beamforming applied to SS/PBCH block #4 at time point t2 202. The UE may acquire, from the base station, an optimal synchronization signal via a beam emitted in the direction where the UE is located. For example, it may be difficult for UE 1 205 to acquire time/frequency synchronization and mandatory system information from the SS/PBCH block through the beam emitted in direction #d4 far away from the location of UE 1.

In addition to the initial access procedure, for the purpose of determining whether the radio link quality of a current cell is maintained at a certain level or higher, the UE may also receive the SS/PBCH block. Furthermore, during a handover procedure in which the UE moves access from the current cell to an adjacent cell, the UE may receive an SS/PBCH block of the adjacent cell in order to determine the radio link quality of the adjacent cell and acquire time/frequency synchronization with the adjacent cell.

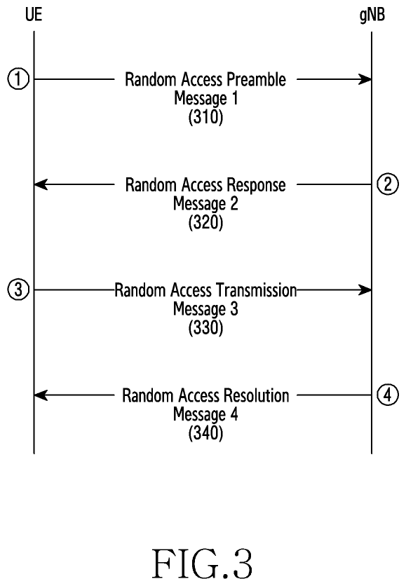

After acquiring an MIB and system information from the base station through the initial access procedure, the UE may perform a random access procedure in order to switch a link to the base station to a connected state (or RRC_CONNECTED state). Upon completing the random access procedure, the UE switches to a connected state in which one-to-one communication between the base station and the UE is possible. Hereinafter, a random access procedure will be described in detail with reference to FIG. 3.

FIG. 3 illustrates a random access procedure according to an embodiment of the disclosure.

Referring to FIG. 3, in the first step 310 of the random access procedure, the UE transmits a random access preamble to the gNB. The random access preamble, which is a message initially transmitted by the UE in the random access procedure, may be referred to as message 1. The gNB may measure the transmission delay value between the UE and the gNB from the random access preamble, and may conduct uplink synchronization. The UE may arbitrarily select which random access preamble is to be used, from a random access preamble set given by system information in advance. In addition, the initial transmission power of the random access preamble may be determined according to the pathloss between the gNB and the UE, which is measured by the UE. Furthermore, the UE may determine the transmission beam direction of the random access preamble from a synchronization signal received from the gNB, thereby transmitting the random access preamble.

In the second step 320, the gNB transmits an uplink transmission timing adjustment command to the UE, based on the transmission delay value measured from the random access preamble received in the first step 310. The gNB may also transmit a command to control power and uplink resources to be used by the UE, as scheduling information. The scheduling information may include control information regarding the UE's uplink transmission beam.

If the UE fails to receive a random access response (RAR) (or message 2) which is scheduling information regarding message 3 from the gNB within a predetermined time in the second step 320, the UE may conduct the first step 310 again. When conducting the first step 310 again, the UE may transmit the random access preamble with transmission power increased by a predetermined step (that is, power ramping), thereby increasing the probability that the gNB will receive the random access preamble.

In the third step 330, the UE transmits uplink data (message 3) including the UE's ID to the gNB through a physical uplink shared channel (PUSCH) by using uplink resources assigned in the second step 320. The transmission timing of the PUSCH for transmitting message 3 may follow a timing control command received from the gNB in the second step 320. In addition, the transmission power of the PUSCH for transmitting message 3 may be determined in consideration of a power control command received from the gNB in the second step 320 and the power ramping value of the random access preamble. The PUSCH for transmitting message 3 may refer to an uplink data signal initially transmitted to the gNB by the UE after the UE has transmitted a random access preamble.

In the fourth step 340, upon determining that the UE has performed a random access without colliding with other UEs, the gNB may transmit data (message 4) including the ID of the UE which has transmitted uplink data in the third step 330 to the corresponding UE. Upon receiving a signal transmitted by the gNB in the fourth step 340, the UE may determine that the random access is successful. In addition, the UE may transmit HARQ-ACK information to the gNB through a physical uplink control channel (PUCCH) so as to indicate whether message 4 is successfully received or not.

If the gNB fails to receive a data signal from the UE due to collision between data transmitted by the UE in the third step 330 and data from another UE, the gNB may no longer transmit data to the UE. In this case, if the UE fails to receive data transmitted from the gNB in the fourth step 340 within a predetermined time, the UE may confirm a random access procedure failure and may restart from the first step 310.

Upon successfully completing the random access procedure, the UE may switch to an RRC connected state, thereby enabling one-to-one communication between the gNB and the UE. The gNB may receive UE capability information reported by the UE in a connected state and may adjust scheduling with reference to the UE capability information from the UE. The UE may inform the gNB of whether the UE supports a specific function or not, the maximum allowed value of the function supported by the UE, and the like through the UE capability information. Therefore, UE capability information reported to the gNB by each UE may have a different value with regard to each UE.

As an example of the UE capability information, the UE may report UE capability information including at least a part of the following control information to the gNB.
Control information regarding the frequency band supported by the UE
Control information regarding the channel bandwidth supported by the UE
Control information regarding the maximum modulation scheme supported by the UE
Control information regarding the maximum number of beams supported by the UE
Control information regarding the maximum number of layers supported by the UE
Control information regarding CSI reporting supported by the UE
Control information regarding whether the UE supports frequency hoping
Control information regarding the bandwidth when carrier aggregation (CA) is supported
Control information regarding whether cross-carrier scheduling is supported when CA is supported

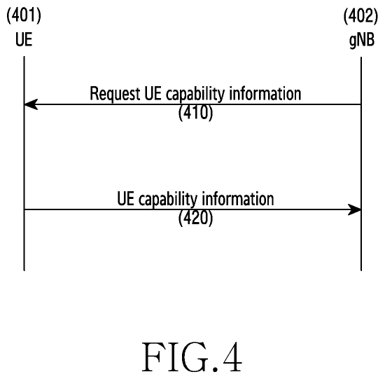

FIG. 4 illustrates a procedure according to an embodiment of the disclosure in which a UE reports UE capability information to a gNB.

Referring to FIG. 4, in step 410, the gNB 402 may transmit a UE capability information request message to the UE 401. At the UE capability information request of the gNB, the UE transmits UE capability information to the gNB in step 420.

Hereinafter, a scheduling method in which the gNB transmits downlink data to the UE, or instructs the UE to transmit uplink data, will be described.

Downlink control information (DCI) refers to control information transmitted from the gNB to a UE through the downlink, and may include downlink data scheduling information or uplink data scheduling information regarding a specific UE. In general, the gNB may independently channel-code DCI with regard to each UE and may transmit the same to each UE through a physical downlink control channel (PDCCH).

With regard to a UE to be scheduled, the gNB may apply and operate a predetermined DCI format according to the purpose, such as whether the same is scheduling information regarding downlink data (downlink assignment), whether the same is scheduling information regarding uplink data (uplink grant), or whether the same is DCI for power control.

The gNB may transmit downlink data to the UE through a physical downlink shared channel (PDSCH). Scheduling information such as detailed mapping locations in time and frequency domains of the PDSCH, the modulation scheme, HARQ-related control information, and power control information, may be provided from the gNB to the UE through DCI related to downlink data scheduling information among DCI transmitted through a PDCCH.

The UE may transmit uplink data to the gNB through a physical uplink shared channel (PUSCH). Scheduling information such as detailed mapping locations in time and frequency domains of the PUSCH, the modulation scheme, HARQ-related control information, and power control information, may be provided from the gNB to the UE through DCI related to uplink data scheduling information among DCI transmitted through a PDCCH.

The time-frequency resource to which the PDCCH is mapped is referred to as a control resource set (CORESET). The CORESET may be configured in all or part of frequency resources in a bandwidth supported by the UE in the frequency domain. One or multiple OFDM symbols may be configured as the same in the time domain, and this may be defined as a control resource set (CORESET) duration. The gNB may configure one or multiple CORESETs for the UE through upper layer signaling (for example, system information, MIB, RRC signaling). The description that a CORESET is configured for the UE may mean that information such as the CORESET identity, the CORESET's frequency location, and the CORESET's symbol length is provided thereto. Pieces of information provided from the gNB to the UE to configure a CORESET may include at least a part of the information included in Table 4 below:

TABLE 4

| | |
|---|---|
| ControlResourceSet ::= | SEQUENCE { |
| controlResourceSetId | ControlResourceSetId, |

(CORESET identity)

| | |
|---|---|
| frequencyDomainResources | BIT STRING (SIZE (45)), |

(frequency domain resources)

| | |
|---|---|
| duration | INTEGER (1..maxCoReSetDuration), |

(CORESET duration)

| | |
|---|---|
| cce-REG-MappingType | CHOICE { |

(CCE-to-REG mapping type)

| | |
|---|---|
| interleaved | SEQUENCE { |
| reg-BundleSize | ENUMERATED {n2, n3, n6}, |

(REG bundle size)

| | |
|---|---|
| interleaverSize | ENUMERATED {n2, n3, n6}, |

```
        (interleaver size)
        shiftIndex
```

| | |
|---|---|
| INTEGER(0..maxNrofPhysicalResourceBlocks-1) | OPTIONAL -- Need S |

```
        (interleaver shift)
    },
```

| | |
|---|---|
| nonInterleaved | NULL |

},

| | |
|---|---|
| precoderGranularity | ENUMERATED {sameAsREG-bundle, |

allContiguousRBs},
(precoding unit)

| | |
|---|---|
| tci-StatesPDCCH-ToAddList | SEQUENCE(SIZE (1..maxNrofTCI- |

StatesPDCCH)) OF TCI-StateId OPTIONAL, -- Cond NotSIB1-initialBWP
(QCL configuration information)

| | |
|---|---|
| tci-StatesPDCCH-ToReleaseList | SEQUENCE(SIZE (1..maxNrofTCI- |

StatesPDCCH)) OF TCI-StateId OPTIONAL, -- Cond NotSIB1-initialBWP
(QCL configuration information)

| | | |
|---|---|---|
| tci-PresentInDCI | ENUMERATED {enabled} | OPTIONAL, |

-- Need S
(QCL indicator configuration information in DCI)

| | |
|---|---|
| pdcch-DMRS-ScramblingID | INTEGER (0..65535) |

OPTIONAL, -- Need S
PDCCH DMRS scrambling identity
}

A CORESET may be configured by N_RB\hat{ }CORESET RBs in the frequency domain and may be configured by N_symb\hat{ }CORESET∈{1,2,3} symbols in the time domain. An NR PDCCH may be configured by one or multiple control channel elements (CCEs). One CCE may be configured by six resource element groups (REGs), and each REG may be defined as one RB during one OFDM symbol. In one CORESET, REGs may be indexed in the time-first order, starting from REG index 0 in the CORESET's first CORESET symbol/lowest RB.

As a PDCCH-related transmission method, an interleaved type and a non-interleaved type may be supported. The gNB may configure, for the UE, whether interleaved or non-interleaved transmission is performed with regard to each CORESET through upper layer signaling. Interleaving may be performed at the REG bundle level. The REG bundle may be defined as one REG or a set of multiple REGs. Based on the gNB's configuration regarding whether interleaved or non-interleaved transmission is performed, the UE may determine a CCE-to-REG mapping type in the corresponding CORESET as in Table 5 below:

TABLE 5
The CCE-to-REG mapping for a control-resource set can be interleaved or non-
interleaved and is described by REG bundles:
- REG bundle i is defined as REGs {iL,iL+1,...,iL + L −1} where L is the REG
bundle size, i = 0,1, ... , N_{REG}^{CORESET} /L − 1, and N_{REG}^{CORESET} = N_{RB}^{CORESET} N_{symb}^{CORESET} is the
number of REGs in the CORESET
- CCE j consists of REG bundles {f(6j/L),f(6j/L+1),...,f(6j/L+6/L−1)} where
f(·) is an interleaver
For non-interleaved CCE-to-REG mapping, L = 6 and f (x) = x.
For interleaved CCE-to-REG mapping, L ∈ {2,6} for N CORESET L ∈
{N_{symb}^{CORESET}, 6} for N_{symb}^{CORESET} ∈ {2,3}. The interleaver is defined by
C = N_{REG}^{CORSET}/(LR) where R ∈ {2,3,6}.

The gNB may provide the UE with configuration information regarding to which symbol the PDCCH is mapped in the slot, the transmission period, and the like through signaling.

A description of a search space for a PDCCH is as follows. The number of CCEs necessary to transmit a PDCCH may be 1, 2, 4, 8, or 16 according to aggregation levels (ALs), and different number of CCEs may be used to implement link adaption of a downlink control channel. For example, in the case of AL=L, one downlink control channel may be transmitted through L CCEs. The UE performs blind decoding for detecting a signal while being no information regarding the downlink control channel, and to this end, a search space indicating a set of CCEs may be defined. The search space is a set of downlink control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured ALs.

The search spaces may be classified into common search spaces (CSSs) and UE-specific search spaces (USSs). A group of UEs or all UEs may search a common search space of the PDCCH in order to receive cell-common control information such as dynamic scheduling regarding system information (SIB) or a paging message. For example, the UE may receive PDSCH scheduling allocation information for reception of system information by searching the common search space for the PDCCH. In the case of a common search space, a group of UEs or all UEs need to receive the PDCCH, and the common search space may thus be defined as a predetermined set of CCEs. Scheduling allocation information regarding a UE-specific PDSCH or PUSCH may be received by searching the UE-specific search space for the PDCCH. The UE-specific search space may be defined UE-specifically as a function of various system parameters and the identity (ID) of the UE.

Configuration information of the search space for the PDCCH may be configured for the UE by the base station through upper layer signaling (e.g., SIB, MIB, or RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a CORESET index for monitoring the search space, and the like. For example, parameters of the search space for the PDCCH may include the following pieces of information given in Table 6 below.

TABLE 6

| | |
|---|---|
| SearchSpace ::= | SEQUENCE { |
| searchSpaceId | SearchSpaceId, |

(search space identity)

| | | |
|---|---|---|
| controlResourceSetId | ControlResourceSetId | OPTIONAL, -- Cond SetupOnly |

```
      (CORESET identity)
  monitoringSlotPeriodicity AndOffset CHOICE {
      (monitoring slot level periodicity and offset)
```

| sl1 | NULL, | |
|---|---|---|
| sl2 | INTEGER (0..1), | |
| sl4 | INTEGER (0..3), | |
| sl5 | INTEGER (0..4), | |
| sl8 | INTEGER (0..7), | |
| sl10 | INTEGER (0..9), | |
| sl16 | INTEGER (0..15), | |
| sl20 | INTEGER (0..19), | |
| sl40 | INTEGER (0..39), | |
| sl80 | INTEGER (0..79), | |
| sl160 | INTEGER (0..159), | |
| sl320 | INTEGER (0..319), | |
| sl640 | INTEGER (0..639), | |
| sl1280 | INTEGER (0..1279), | |
| sl2560 | INTEGER (0..2559) | |
| } | OPTIONAL, -- Cond Setup | |
| duration | INTEGER (2..2559) | OPTIONAL, -- Need R |

(monitoring duration)

| | | |
|---|---|---|
| monitoringSymbolsWithinSlot | BIT STRING (SIZE (14)) | OPTIONAL, -- Cond |

Setup
(monitoring symbol locations within slot)

| | |
|---|---|
| nrofCandidates | SEQUENCE { |

(number of PDCCH candidates for each aggregation level)

| | |
|---|---|
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |
| } | OPTIONAL, -- Cond Setup |
| searchSpaceType | CHOICE { |

(search space type)

| | |
|---|---|
| common | SEQUENCE { |

(common search space)

| | |
|---|---|
| dci-Format0-0-AndFormat1-0 | SEQUENCE { |

...

| | |
|---|---|
| } | OPTIONAL, -- Need R |
| dci-Format2-0 | SEQUENCE { |
| nrofCandidates-SFI | SEQUENCE { |

```
          aggregationLevel1 ENUMERATED {n1, n2} OPTIONAL, -- Need R
          aggregationLevel2 ENUMERATED {n1, n2} OPTIONAL, -- Need R
          aggregationLevel4 ENUMERATED {n1, n2} OPTIONAL, -- Need R
          aggregationLevel8 ENUMERATED {n1, n2} OPTIONAL, -- Need R
          aggregationLevel16 ENUMERATED {n1, n2} OPTIONAL -- Need R
        },
        ...
```

| | |
|---|---|
| } | OPTIONAL, -- Need R |
| dci-Format2-1 | SEQUENCE { |

...

| | |
|---|---|
| } | OPTIONAL, -- Need R |
| dci-Format2-2 | SEQUENCE { |

...

| | |
|---|---|
| } | OPTIONAL, -- Need R |
| dci-Format2-3 | SEQUENCE { |
| dummy 1 | ENUMERATED {sl1, sl2, sl4, sl5, sl8, sl10, sl16, sl20} |

OPTIONAL, -- Cond Setup

| | |
|---|---|
| dummy2 | ENUMERATED {n1, n2}, |

...

| | |
|---|---|
| } | OPTIONAL -- Need R |

},

| | |
|---|---|
| ue-Specific | SEQUENCE { |

(UE-specific search space)

| | |
|---|---|
| dci-Formats | ENUMERATED {formats0-0-And-1-0, formats0-1-And-1-1}, |

```
      ...,
    }
```

| | |
|---|---|
| } | OPTIONAL -- Cond Setup2 |

}

According to configuration information, the base station may configure one or multiple search space sets for the UE. According to some embodiments, the base station may configure search space set 1 and search space set 2 for the UE. In search space set 1, the UE may be configured to monitor DCI format A scrambled by an X-RNTI in a common search space, and in search space set 3, the UE may be configured to monitor DCI format B scrambled by a Y-RNTI in a UE-specific search space.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

In a common search space, the UE may monitor combinations of DCI formats and RNTIs given below. Obviously, the example given below is not limiting.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In a UE-specific search space, the UE may monitor combinations of DCI formats and RNTIs given below. Obviously, the example given below is not limiting.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI The RNTIs may follow the definition and usage given below.
Cell RNTI (C-RNTI): used to schedule a UE-specific PDSCH
Temporary cell RNTI (TC-RNTI): used to schedule a UE-specific PDSCH
Configured scheduling RNTI (CS-RNTI): used to schedule a semi-statically configured UE-specific PDSCH
Random access RNTI (RA-RNTI): used to schedule a PDSCH in a random access step
Paging RNTI (P-RNTI): used to schedule a PDSCH in which paging is transmitted
System information RNTI (SI-RNTI): used to schedule a PDSCH in which system information is transmitted
Interruption RNTI (INT-RNTI): used to indicate whether a PDSCH is punctured
Transmit power control for PUSCH RNTI (TPC-PUSCH-RNTI): used to indicate a power control command regarding a PUSCH
Transmit power control for PUCCH RNTI (TPC-PUCCH-RNTI): used to indicate a power control command regarding a PUCCH
Transmit power control for SRS RNTI (TPC-SRS-RNTI): used to indicate a power control command regarding an SRS

The DCI formats enumerated above may follow the definitions given in Table 7 below.

TABLE 7

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM symbol(s) |
| | where UE may assume no transmission is intended for the UE |
| 2_2 | Transmission of TPC commands for PUCCH and PUSCH |
| 2_3 | Transmission of a group of TPC commands for SRS transmissions |
| | by one or more UEs |

In a 5G system, the search space at aggregation level L in connection with CORESET p and search space set s may be expressed by Equation 1 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i . \qquad Equation 1$$

L: aggregation level
n_{CI}: carrier index
N_{CCE,p}: total number of CCEs existing in control resource set p
n_{s,f}^{μ}: slot index
M_{s,max}^{(L)}: number of PDCCH candidates at aggregation level L
m_{s,n}_{_{CI}}=0, . . . , M_{s,max}^{(L)}−1: PDCCH candidate index at aggregation level L

$$\begin{matrix}i = 0 , … , L - 1 \\ {Y}_{p , {n}_{s , f}^{μ}} = ( {A}_{p} \cdot {Y}_{p , {n}_{s , f}^{μ} - 1} ) mod D ,\end{matrix}$$

Y_{p,-}1=n_{RNTI}≠0, Aₚ=39827 for p mod 3=0, Aₚ=39829 for p mod 3=1, Aₚ=39839 for p mod 3=2, D=65537
n_{RNTI}: UE identity

The

$${Y}_{p , {n}_{s , f}^{μ}}$$

value may correspond to 0 in the case of a common search space.

The

$${Y}_{p , {n}_{s , f}^{μ}}$$

value may correspond to a value changed by the UE's identity (C-RNTI or ID configured for the UE by the base station) and the time index in the case of a UE-specific search space.

The data rate may be increased through a spatial multiplexing method which uses multiple transmission/reception antennas, as a scheme for supporting a super-fast data service. In general, the number of necessary power amplifiers (PAs) increases in proportion to the number of transmission/reception antennas provided in a gNB or a UE. The maximum output of the gNB and the UE depends on PA characteristics, and the gNB's maximum output generally varies depending on the size of the cell covered by the gNB. The maximum output is commonly indicated using a dBm unit. The UE's maximum output is commonly 23 dBm or 26 dBm.

As an example of a commercial 5G gNB, the gNB may include 64 transmission antennas in a frequency band of 3.5 GHz and 64 power amplifiers corresponding thereto, and may operate at a bandwidth of 100 MHz. Consequently, the amount of power consumed by the gNB increases in proportion to the output of the power amplifiers and the operating time of the power amplifiers. Compared with LTE gNBs, 5G gNBs are characterized by having larger bandwidths and more transmission antennas because of higher operating frequency bands thereof. Such characteristics have the advantage of higher data rates, but incur the cost of larger amounts of energy consumed by the gNBs. Therefore, energy consumed by the entire mobile communication network increases in proportion to the number of gNBs constituting the mobile communication network.

As described above, energy consumption by a gNB depends on power amplifier operations to a large extent. Power amplifiers are involved in gNB transmission operations, and the gNB's DL transmission operation is highly related to the gNB's energy consumption. The gNB's UL reception operation does not occupy a relatively large proportion of the gNB's energy consumption. Physical channels and physical signals transmitted through the downlink by the gNB are as follows:
PDSCH: a downlink data channel including data to be transmitted to one or multiple UEs
PDCCH: a downlink control channel including scheduling information regarding a PDSCH and a PUSCH. Alternatively, the PDCCH alone may transmit control information such as a slot format and a power control command without a PDSCH or PUSCH to be scheduled. Scheduling information includes information regarding resources to which the PDSCH or PUSCH is mapped, HARQ-related information, power control information, and the like.
PBCH: a downlink broadcast channel for providing MIB which is essential system information necessary for the UE's data channel and control channel transmission/reception
PSS: is a signal serving as a reference for DL time/frequency synchronization, and provides cell ID partial information.
SSS: a signal which serves as a reference for DL time and/or frequency (hereinafter, referred to as time/frequency) synchronization, and which provides cell ID remaining partial information.
Demodulation reference signal (DM-RS): a reference signal for the UE's channel estimation regarding each of the PDSCH, PDCCH, and PBCH
CSI-RS: a downlink signal serving as a reference for the UE's downlink channel state measurement
Phase-tracking reference signal (PT-RS): a downlink signal for phase tracking

In terms of the gNB's energy saving, if the gNB stops the downlink transmission operation, the power amplifier operation stops accordingly, thereby contributing to the gNB's energy saving. Not only the power amplifiers, but also other gNB devices (for example, baseband devices) have reduced operations, thereby additionally saving the energy. Likewise, additional energy saving is possible if it is possible to stop the uplink reception operation, although the uplink reception operation occupies a relatively small proportion in the entire energy consumption by the gNB.

The gNB's downlink transmission operation basically depends on the amount of downlink traffic. For example, if there is no data to be transmitted to the UE through the downlink, the gNB has no need to transmit a PDSCH and a PDCCH for scheduling the PDSCH. Alternatively, if transmission can be suspended for a while because data is not sensitive to transmission delay, for example, the gNB may not transmit the PDSCH and/or the PDCCH. Hereinafter, a method for reducing the gNB's energy consumption by transmitting no PDSCH and/or PDCCH related to data traffic, or by appropriately adjusting the same, as described above, will be referred to as “gNB energy saving method 1-1” for convenience of description.

To the contrary, physical channels and physical signals such as PSS, SSS, PBCH, and CSI-RS are characterized in that they are repeatedly transmitted at a promised cycle, regardless of data transmission regarding the UE. Therefore, the UE may continuously update the downlink time/frequency synchronization, the downlink channel state, the radio link quality, and the like although no data is received. That is, the PSS, SSS, PBCH, and CSI-RS need to be transmitted through the downlink regardless of the downlink data traffic, and this causes energy consumption by the gNB. Therefore, the gNB's energy consumption may be reduced by making adjustment such that transmission of signals having no (or little) relevance to data traffic occurs less frequently (hereinafter, referred to as “gNB energy saving method 1-2”).

Through “gNB energy saving method 1-1” or “gNB energy saving method 1-2”, operations of RF devices, baseband devices, and the like related to the gNB's power amplifier operations may be stopped or minimized during a time interval in which the gNB makes no downlink transmission, thereby maximizing the gNB's energy saving.

As another method, some of the gNB's antennas or power amplifiers may be switched off, thereby reducing the gNB's energy consumption (hereinafter, referred to as “gNB energy saving method 2”). In this case, the gNB's energy saving may involve a countereffect such as reduced cell coverage or reduced throughput. For example, there may be a gNB which has 64 transmission antennas in a frequency band of 3.5 GHz and 64 power amplifiers corresponding thereto, and which operates in a bandwidth of 100 MHz, as described above. If four transmission antennas and four PAs are solely activated during a predetermined time interval to save the gNB's energy, and if the remainders are switched off, the energy consumption by the gNB is reduced to about 1/16 (=4/64) during the time interval. If four transmission antennas and four power amplifiers are solely activated during a predetermined time interval, and if the remainders are switched off, it becomes difficult to accomplish the same cell coverage and throughput as when 64 antennas and power amplifiers are assumed, due to the reduced maximum transmission power and reduced beamforming gain.

In the following description, a gNB mode to which operations for gNB energy saving (distinguished from normal gNB operations) are applied will be referred to as a gNB energy saving (ES) mode, and a gNB mode to which normal gNB operations are applied will be referred to as a gNB normal mode.

As another scheme for supporting a super-fast data service, signal transmission/reception in super-broad bandwidths (tens of MHz to hundreds of MHZ, or multiple GHz) may be supported in 5G systems. Signal transmission/reception in super-broad bandwidths may be supported through a single component carrier (CC) or through a carrier aggregation (CA) technology in which multiple CCs are combined. If a mobile communication operator fails to secure a bandwidth of frequencies sufficient to provide a super-fast data service by using a single CC, the CA technology may combine respective CCs having relatively small bandwidth sizes such that the total sum of frequency bandwidths increases, thereby enabling a super-fast data service.

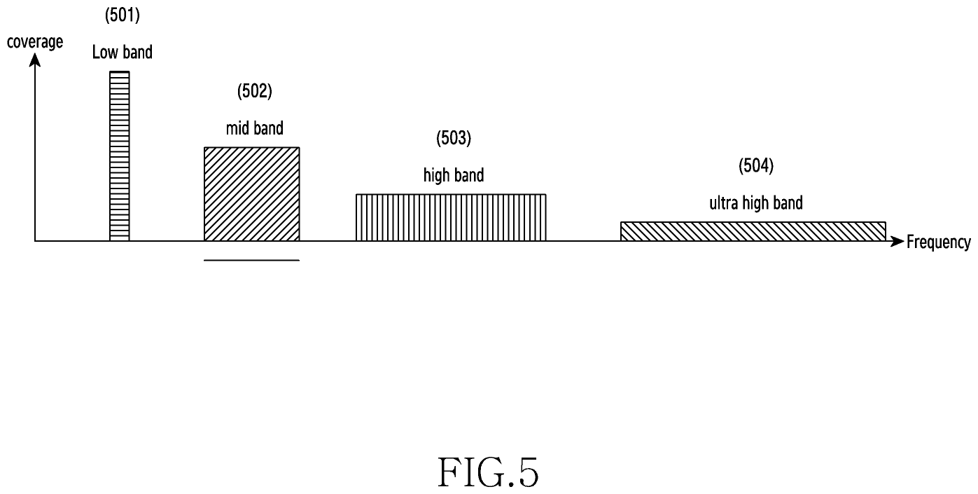

FIG. 5 illustrates the correlation between the frequency band, coverage, and bandwidth according to an embodiment of the disclosure. As described above, 5G systems utilize a wide range of frequency bands ranging from hundreds of MHz to tends of GHz. In general, the lower the frequency band, the larger the coverage because of the lower degree of pathloss, and the larger the frequency band, the smaller the coverage because of the higher degree of pathloss. In a low-frequency band, fewer frequencies are available for mobile communication, and the bandwidth is smaller. On the other hand, in a high-frequency band, it is easier to secure a broad-bandwidth frequency, and the same is thus appropriate for a super-fast data service. Evolution of mobile communication systems evolve has been followed by efforts to discover and utilize new frequency bands. For example, in the next-generation (6th generation (6G)) mobile communication systems, the terahertz (THz) (1012 Hz) band is considered as one of candidate frequencies, although still in the early phase of discussion. In general, a mobile communication operator secures multiple frequency bands and provide users with mobile communication services. For example, a mobile communication operator may combine already-secured LTE system frequency band and a newly-secured 5G system frequency band, thereby operating a system in which LTE and 5G are combined. As another example, a mobile communication operator may secure multiple 5G system frequency bands and then combine the multiple frequency bands, thereby providing a mobile communication service through 5G CA. As described above, characteristics such as the coverage and bandwidth vary according to the frequency band, and mobile communication services based on a combination of multiple frequency bands are gaining dominance over mobile communication services based on a single frequency band.

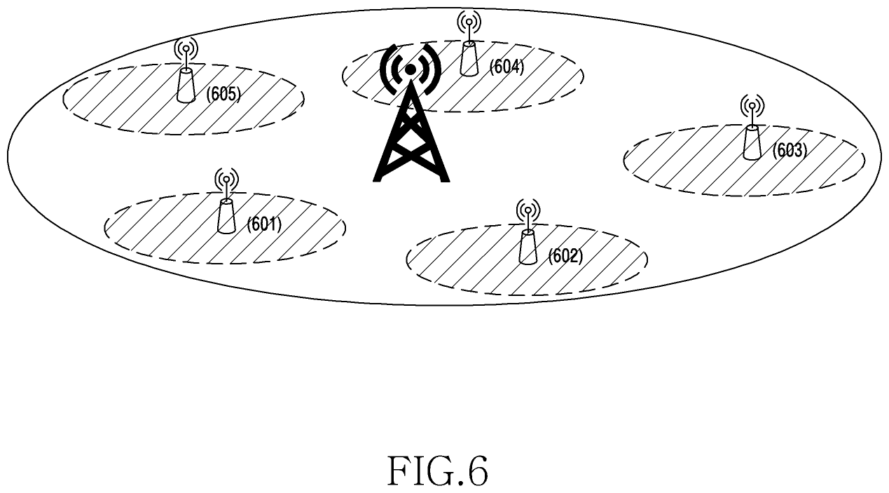

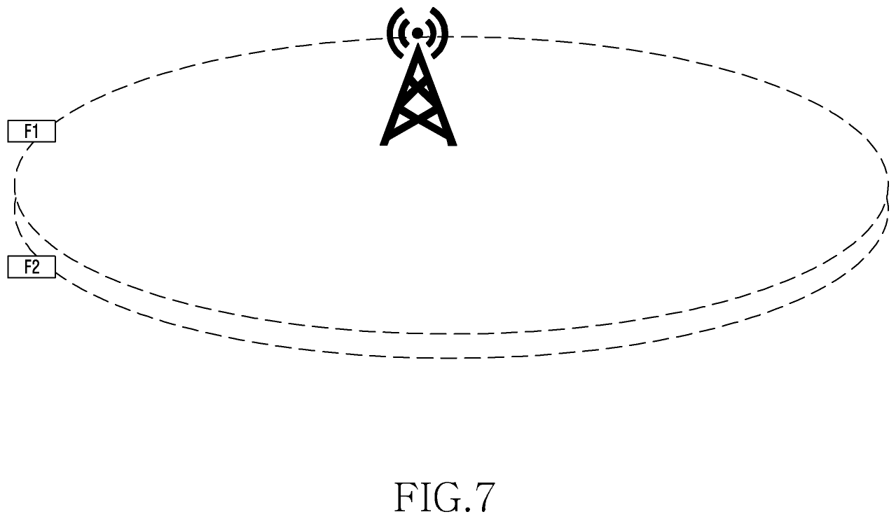

FIG. 6 and FIG. 7 illustrate a representative scenario of gNB disposition to which operations of the disclosure are applied according to an embodiment of the disclosure.

FIG. 6 illustrates a gNB disposition scenario according to an embodiment of the disclosure.

Referring to FIG. 6, carriers include a carrier 601 operating at frequency F1 (hereinafter referred to as “macro cell” for convenience of description) and carriers 602, 603, 604, 605, and 606 operating at frequency F1 or F2 (hereinafter referred to as “small cells”) (F1<F2). It is assumed that a “macro cell” provides a wide cell coverage due to a relatively large maximum output, but a “small cell” provides a limited cell coverage due to a relatively small maximum output. The size of a circle illustrated in FIG. 6 indicates the size of the coverage which each carrier can provide. FIG. 6 illustrates multiple “small cells” coexisting within the coverage of the “macro cell”. The “macro cell” and the “small cells” connected in a wired or wireless manner with each other and thus can efficiently cooperate. In the disclosure, a gNB may be a combination of a “macro cell” and a “small cell”. Alternatively, a gNB may be implemented separately with regard to each of a “macro cell” and a “small cell”. If a “macro cell” and a “small cell” are implemented as one gNB, each of the “macro cell” and “small cell” may be referred to as a transmission reception point (TRP).

FIG. 7 illustrates a gNB disposition scenario according to an embodiment of the disclosure.

FIG. 7 illustrates a CA system in which a carrier (cell 1) operating at frequency F1 and a carrier (cell 2) operating at frequency F2 are combined (F1≠F2). FIG. 7 illustrates an example, in which CA is applied through one gNB. FIG. 7 illustrates a case in which cell coverages provided by respective carriers are similar, unlike the case in FIG. 6.

The gist of the disclosure is that, in order to reduce the gNB's energy consumption, the transmission power of signals transmitted by the gNB is adjusted. That is, assuming that the gNB transmission power in a gNB normal mode is P_normal, and the gNB transmission power in a gNB energy saving mode is P_energysaving, the transmission power of signals transmitted by the gNB is adjusted such that the relation P_normal>P_energysaving is satisfied. The above-described “gNB energy saving method 2” may be regarded as a special case in which P_energysaving=0. The unit of P_normal and P_energysaving may be Watt.

In the case of the scenario in FIG. 6 or FIG. 7, the gNB may adjust the transmission power of signals transmitted by the gNB in at least one of multiple cells constituting the system, thereby reducing energy consumption by the gNB. For example, in the case of FIG. 6, the gNB may adjust the transmission power of at least one “small cell” and may maintain the transmission power of the “macro cell” such that the cell coverage through the “macro cell” is maintained, and energy consumption by the gNB in the “small cell” is reduced. In the case of FIG. 7 as well, the gNB may adjust the transmission power of cell 2 and may maintain the same transmission power of cell 1, thereby maintaining the cell coverage and reducing energy consumption by the gNB.

The transmission parameter may be associated with the bandwidth and expressed in terms of power spectral density (PSD). The unit of PSD is commonly Watt/Hz, which means power per unit bandwidth. A transmission bandwidth refers to a bandwidth occupied by a signal transmitted by the gNB, and may be expressed by using a MHz unit. As a concept similar to the PSD, energy per resource element (EPRE) may be used. The EPRE means energy per RE. The EPRE may be expressed by a dBm unit.

As described above, gNB's power consumption may be reduced by adjusting transmission parameters for energy saving, but the cell throughput and coverage may decrease. In addition, as a method for overcoming this, transmission parameters may be adjusted at a short interval (for example, TTI and symbol level), thereby minimizing the decrease in cell throughput and coverage. In embodiment 1 below, a method for adjusting the transmission power of signals transmitted by the gNB, among transmission parameters, at a shorter time interval will be presented. In addition, in embodiment 2, a method for adjusting the beamforming, among transmission parameters, at a shorter time interval will be presented. However, if the gNB adjusts at least the above-mentioned transmission parameters, the UE's CSI measurement may be affected. Specifically, the UE measures CSI, based on information regarding the transmission power of signals transmitted by the gNB. If transmission power of signals transmitted by the gNB is changed, the UE needs to measure CSI, based on information regarding the changed transmission power, and report the same to the gNB. In addition, if the beam direction is changed by beamforming of signals transmitted by the gNB, the UE needs to measure CSI, based on received signals related to the changed beam, and report the same to the gNB. In embodiment 3 below, a method for measuring and reporting CSI when the transmission power of signals transmitted by the gNB is adjusted, will be presented. In addition, in embodiments 4 and 5 below, a method for measuring and reporting CSI when the gNB adjusts beamforming, will be presented.

Hereinafter, operations in which a UE measures CSI and reports the same to a gNB, proposed in the disclosure, will be described with reference to specific embodiments. Methods proposed in the disclosure may be applied to a case in which a transmission parameter is adjusted at a short time interval for the sake of the gNB's energy saving and cell throughput and coverage management. It is to be noted that, in the disclosure, one or more of the following embodiments may be combined and used.

### First Embodiment

In the first embodiment, a method in which a gNB adjusts transmission power of a downlink signal will be described.

In general, the transmission power of a downlink common signal (PSS, SSS, PBCH, CSI-RS, or the like) transmitted by a gNB is maintained as it is, except for a special case, once determined in consideration of the cell coverage or the like in the gNB installation step. However, if energy saving is necessary with regard to the gNB, a method in which the gNB quickly lowers the transmission power of the downlink common signal, thereby increasing the energy saving effect, is necessary. In addition, the gNB needs to quickly increase the transmission power such that the cell throughput and coverage are maintained.

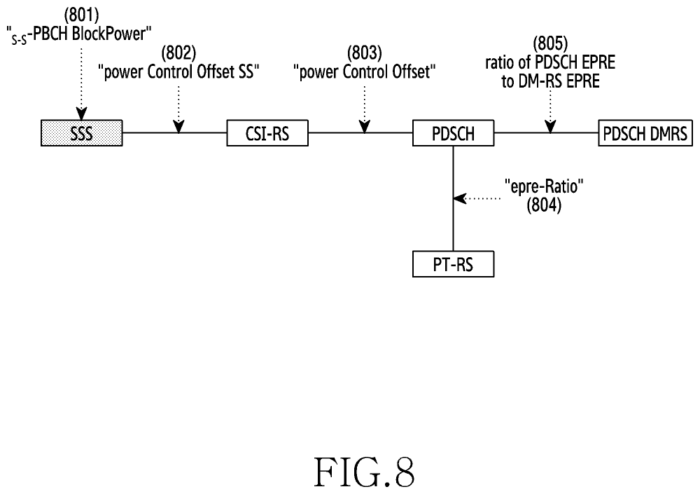

FIG. 8 illustrates the correlation between downlink signal transmission power configurations according to an embodiment of the disclosure. The correlation between downlink signal transmission power configurations in FIG. 8 may correspond to the correlation between downlink signal EPRE configurations in a 5G system. Basically, the gNB configures EPRE of SSS, adjusts CSI-RS EPRE with reference to the SSS EPRE, and adjust PDSCH EPRE in comparison with CSI-RS EPRE, PT-RS EPRE in comparison with PDSCH EPRE, PDSCH DMRS EPRE in comparison with PDSCH EPRE, and the like. That is, EPRE relations of the downlink signal are associated with each other. The gNB may inform the UE of EPRE of the downlink signal in the following method.
“ss-PBCH-BlockPower” 801: a parameter for adjusting EPRE of SSS. The gNB informs the UE thereof through signaling. It is expressed by a dBm unit. PSS EPRE, PBCH EPRE, and PBCH DMRS EPRE are commonly applied with the same value as SSS EPRE.
“powerControlOffsetSS” 802: a parameter for adjusting the power offset of CSI-RS RE and SSS RE. The gNB informs the UE thereof through signaling. It is a ratio between CSI-RS EPRE and SSS EPRE, and is expressed by dB.
“powerControlOffset” 803: a parameter for adjusting the power offset of PDSCH RE and CSI-RS RE. The gNB informs the UE thereof through signaling. It is a ratio between PDSCH EPRE and CSI-RS EPRE, and is expressed by dB.
“epre-Ratio” 804: a parameter for adjusting the between PT-RS EPRE and PDSCH EPRE. The gNB informs the UE thereof through signaling. It expressed by dB.
ratio of PDSCH EPRE to PDSCH DM-RS EPRE 805: the ratio between PDSCH EPRE and PDSCH DM-RS EPRE is determined according to the PDSCH DM-RS configuration separately configured by the gNB.

The gNB may adjust the transmission power of a downlink common signal and inform the UE thereof in the following signaling methods. A method in which the UE measures and reports CSI accordingly will be presented with reference to the third embodiment described later. It is to be noted that the time interval at which the gNB adjusts transmission power may vary according to the following methods.
Method 1 (RRC signaling): the gNB may inform the UE of the above-described “ss-PBCH-BlockPower”, “powerControlOffsetSS”, or a corresponding value through RRC signaling as in existing methods. The signaling error probability may decrease substantially through HARQ and ARQ procedures, but a relatively long time is necessary to complete signaling and to apply the same to the UE.
Method 2 (MAC-CE signaling): the gNB may inform the UE of the above-described “ss-PBCH-BlockPower”, “powerControlOffsetSS”, or a corresponding value through MAC-CE signaling. The MAC-CE signaling may have a signaling error probability in the middle between the error probability of RRC signaling and the error probability of physical layer signaling. The time necessary to complete MAC-CE signaling may also be in the middle between the RRC signaling time and the physical layer signaling time.
Method 3 (physical layer signaling, DCI): the gNB may inform the UE of the above-described “ss-PBCH-BlockPower”, “powerControlOffsetSS”, or a corresponding value through physical layer signaling. The physical layer signaling is characterized in that a short time is necessary to complete the signaling, but the error probability is relatively high. The physical layer signaling may be transmitted through a PDCCH. For example, the gNB may signal the same through a group-common PDCCH which is commonly applied to multiple UEs, or through a PDCCH which schedules a predetermined UE's PDSCH/PUSCH. When the group-common PDCCH is used, the gNB may define and operate a separate CORESET, search space, DCI format, or RNTI in order to adjust the transmission power of downlink signals. For example, the gNB may introduce and operate a CORESETES as a CORESET of a PDCCH for gNB energy saving, SearchSpceES as a search space of a PDCCH for gNB energy saving, DCI 2_ES as a DCI format of a PDCCH for gNB energy saving, or ES-RNTI as RNTI for gNB energy saving. In order to acquire signaling that indicates gNB energy saving, the UE may monitor the CORESETES and search space SearchSpceES, thereby detecting the same according to DCI format DCI 2_ES, and may acquire signaling for gNB energy saving by descrambling the same by ES-RNTI.
Method 4 (a combination of RRC signaling and MAC signaling): RRC signaling in method 1 and MAC signaling in method 2 may be combined. The gNB may first inform the UE of all or part of the signaling value for adjusting transmission power of downlink signals through RRC signaling, and may additionally inform the UE of the value of transmission power of downlink signals to be finally applied by the UE, among signaling values indicated through RRC signaling, through MAC signaling. Through such stepwise signaling, the gNB may divide the amount of information to be signaled at one time, and may compromise on the advantage/disadvantage of each signaling method.
Method 5 (a combination of RRC signaling and physical layer signaling): RRC signaling in method 1 and physical layer signaling in method 3 may be combined. Similarly to method 4, the gNB may first inform the UE of all or part of the signaling value for adjusting transmission power of downlink signals through RRC signaling, and may additionally inform the UE of the value of transmission power of downlink signals to be finally applied by the UE, among signaling values indicated through RRC signaling, through physical layer signaling. Through such stepwise signaling, the gNB may divide the amount of information to be signaled at one time, and may compromise on the advantage/disadvantage of each signaling method.

The signaling value may indicate an SSS EPRE value adjusted by the gNB, or a value corresponding thereto. Alternatively, the signaling value may individually indicate the EPRE value of each downlink common signal, such as SSS EPRE, CSI-RS EPRE, or PT-RS EPRE, or a value corresponding thereto. In addition, the signaling value may indicate the absolute value of a newly changed EPRE value, or may indicate the proportion or percentage with regard to the EPRE in the gNB normal mode.

### Second Embodiment

In the second embodiment, a method in which a gNB adjusts beamforming of a downlink signal will be described.

In general, a downlink common signal (PSS, SSS, PBCH, CSI-RS, or the like) and a data signal (PDSCH) transmitted by a gNB are beamformed and then transmitted such that the UE can easily receive the same. If the UE reports another beam direction preferred thereby, or if the gNB determines that there is no need to change the beam direction, the beam direction may be maintained as it is. However, if energy saving is necessary with regard to the gNB, a method in which the gNB quickly lowers the transmission power of the downlink common signal, thereby increasing the energy saving effect, is necessary. In addition, the gNB needs to quickly increase the transmission power or quickly adjust beamforming toward the UE such that the cell throughput and coverage are maintained.

The gNB may inform the UE that the beam direction of the downlink common signal and the data signal has changed, by using the following signaling methods. The gNB may inform the UE that the beam direction has changed by indicating CSI measurement restriction (MR). However, the UE does not need to limitedly interpret that, if MR is indicated, the gNB has changed the beam direction. If the gNB has indicated MR, the UE has only to measure and report CSI accordingly. In the fourth embodiment described later, a method wherein, if the gNB indicates that MR is enabled, the UE measures and reports CSI accordingly. It is to be noted that the time interval at which the gNB adjusts the beam direction and MR may vary according to the following methods.
Method 1 (RRC signaling): the gNB may inform the UE of whether MR is enabled or disabled through RRC signaling. The signaling error probability may decrease substantially through HARQ and ARQ procedures, but a relatively long time is necessary to complete signaling and to apply the same to the UE.
Method 2 (MAC-CE signaling): the gNB may inform the UE of whether MR is enabled or disabled through MAC-CE signaling. The MAC-CE signaling may have a signaling error probability in the middle between the error probability of RRC signaling and the error probability of physical layer signaling. The time necessary to complete MAC-CE signaling may be similarly in the middle between the RRC signaling time and the physical layer signaling time.
Method 3 (physical layer signaling, DCI): the gNB may inform the UE of whether MR is enabled or disabled through physical layer signaling. The physical layer signaling is characterized in that a short time is necessary to complete the signaling, but the error probability is relatively high. The physical layer signaling may be transmitted through a PDCCH. For example, the gNB may signal the same through a group-common PDCCH which is commonly applied to multiple UEs, or through a PDCCH which schedules a predetermined UE's PDSCH/PUSCH. When the group-common PDCCH is used, the gNB may define and operate a separate CORESET, search space, DCI format, or RNTI in order to indicate whether MR is enabled or not. For example, the gNB may introduce and operate a CORESETES as a CORESET of a PDCCH for gNB energy saving, SearchSpceES as a search space of a PDCCH for gNB energy saving, DCI 2_ES as a DCI format of a PDCCH for gNB energy saving, or ES-RNTI as RNTI for gNB energy saving. In order to acquire signaling that indicates whether MR is enabled or not from the gNB, the UE may monitor the CORESETES and search space SearchSpceES, thereby detecting the same according to DCI format DCI 2_ES, and may acquire signaling indicating whether MR is enabled or not from the gNB by descrambling the same by ES-RNTI. The DCI in method 3 may be DCI for UL grant.
Method 4 (a combination of RRC signaling and MAC signaling): RRC signaling in method 1 and MAC signaling in method 2 may be combined. The gNB may first inform the UE of all or part of the signaling value indicating whether MR is enables or disabled through RRC signaling, and may additionally inform the UE of MR information to be finally applied by the UE, among signaling values indicated through RRC signaling, through MAC signaling. Through such stepwise signaling, the gNB may divide the amount of information to be signaled at one time, and may compromise on the advantage/disadvantage of each signaling method.
Method 5 (a combination of RRC signaling and physical layer signaling): RRC signaling in method 1 and physical layer signaling in method 3 may be combined. Similarly to method 4, the gNB may first inform the UE of all or part of the signaling value indicating whether MR is enables or disabled through RRC signaling, and may additionally inform the UE of the value of transmission power of downlink signals to be finally applied by the UE, among signaling values indicated through RRC signaling, through physical layer signaling. Through such stepwise signaling, the gNB may divide the amount of information to be signaled at one time, and may compromise on the advantage/disadvantage of each signaling method.

The signaling value may indicate a value indicating whether MR is “enabled (or configured)” or “disabled (or not configured)”, or a value corresponding thereto.

### Third Embodiment

In the third embodiment, a method for measuring and reporting CSI when the transmission power of signals transmitted by a gNB is adjusted at a shorter time interval, as described in the first embodiment, will be presented.

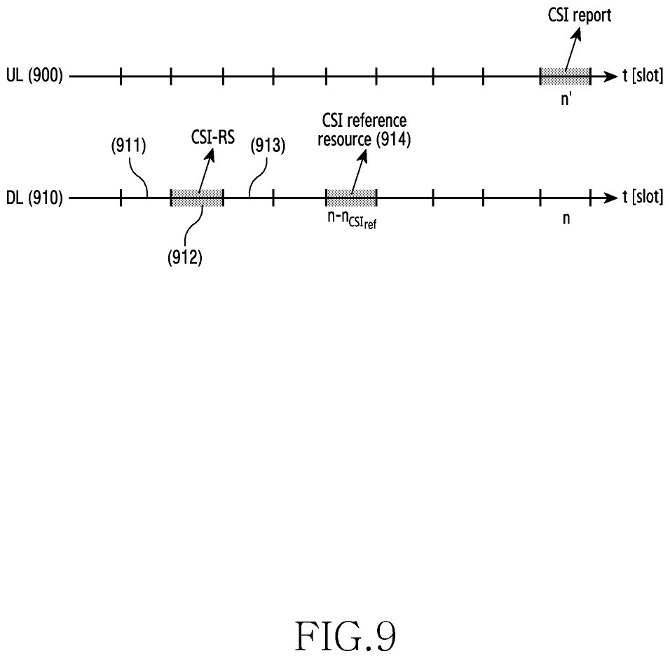

FIG. 9 illustrates CSI measurement and CSI reporting by a UE according to an embodiment of the disclosure.

Referring to FIG. 9, a UL 900 slot and a DL 910 slot are illustrated. Assuming that the UE is configured to report CSI in UL 900 slot n′, DL 910 slot n corresponding thereto may be expressed by the following equation:

$$n = ⌊ {n}^{′} \cdot \frac{{2}^{{μ}_{D L}}}{{2}^{{μ}_{U L}}} ⌋ + ⌊ ( \frac{{N}_{s lot , offset , UL}^{C A}}{{2}^{{μ}_{offset , UL}}} - \frac{{N}_{s lot , offset , DL}^{C A}}{{2}^{{μ}_{offset , DL}}} ) * {2}^{{μ}_{D L}} ⌋ \qquad Equation 2$$

μ_{DL}, ρ_{UL}: DL, UL subcarrier spacing configuration values
N_{slot,offset}^{CA}, μ_{offset}: parameters related to carrier aggregation (CA) configured at the upper level with regard to DL and UL.

Next, assuming that the UE is configured to report CSI in UL 900 slot n′, and the DL 910 slot corresponding thereto is n, the CSI reference resource 914 in the DL slot 910 may be expressed by the following equation:

$$n - {n}_{{CSI}_{r e f}} - {K}_{offset} * \frac{{2}^{{μ}_{DL}}}{{2}^{{μ}_{{K}_{offset}}}} \qquad Equation 3$$

μ_{DL}: a DL subcarrier spacing configuration value
K_{offset}: a parameter configured at the upper level to be 0 in frequency range 1.
μ_{K}_{_{offset}}: a subcarrier spacing configuration value regarding K_{offset}
n_{CSI}_{_{ref}}: refers to the time needed by the UE to report CSI by using measured channel information. If one CSI-RS/SSB resource is configured, a value of at least 4*2^{μ}^{_{DL}} may be configured therefor. If multiple CSI-RS/SSB resources are configured, a value of at least 5*2^{μ}^{_{DL}} may be configured therefor.

FIG. 9 illustrates a case in which K_{offset} in Equation 3 above is 0, the UE is configured to report CSI in UL 900 slot n′, the DL 910 slot corresponding thereto is n, and the CSI reference resource 914 in the DL 910 slot is n−n_{CSI}_{_{ref}}.
In general, the UE may perform channel measurement by using a CSI-RS received prior to a CSI reference resource. It may be determined by UE implementation to what extent the UE will use the CSI-RS preceding the CSI reference resource. For example, a measurement window for the same may be used. Such a method may be identically applied when interference is measured by using a CSI-RS. Unlike this, when the transmission power of signals transmitted by the gNB is adjusted at a short time interval through MAC-CE or DCI as presented in the first embodiment, the UE may need to measure CSI, based on information regarding changed transmission power, and then report the same to the gNB. Therefore, there is a need to define a CSI measurement method in such a case. Specifically, the following methods may be considered.
If the transmission power of signals transmitted by the gNB is indicated by a MAC-CE, the UE may report CSI by using at least one CSI-RS for channel measurement received after the slot in which the corresponding indication is enabled, and a CSI-RS or CSI-IM for interference measurement. The CSI-RS and CSI-IM need to be received prior to the CSI reference resource. If there are no CSI-RS and CSI-IM satisfying this requirement, the UE drops CSI reporting.

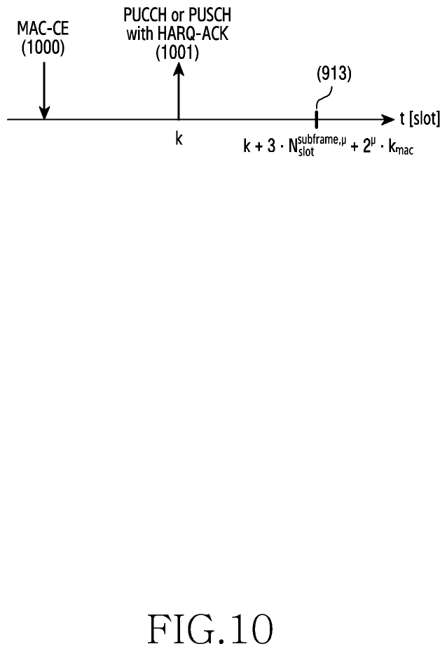

FIG. 10 illustrates a timepoint at which an indication through a MAC-CE is enabled. Referring to FIG. 10, assuming that the UE has received a MAC-CE in a slot 1000 and has transmitted a HARK-ACK regarding MAC-CE reception in slot k 1001, the timepoint at which an indication through a MAC-CE is enabled may be defined as slot k+3*Nₛₗₒₜ^{subframe,μ}+2^{μ}*k_{mac}. Table 2 or 3 above is referred to regarding Nₛₗₒₜ^{subframe,μ}. In addition, k_{mac} is a parameter configured at the upper level.
Assuming that the transmission power of signals transmitted by the gNB is indicated by DCI, the UE may report CSI by using at least one CSI-RS for channel measurement received after the slot in which the DCI is received, and a CSI-RS or CSI-IM for interference measurement. The CSI-RS and CSI-IM need to be received prior to the CSI reference resource. If there are no CSI-RS and CSI-IM satisfying this requirement, the UE drops CSI reporting.

Referring to FIG. 9, if transmission power which the gNB has indicated by a MAC-CE according to the above method is enabled in the slot 911 or 912, the UE may report CSI by using this because there is a CSI-RS received prior to the CSI reference resource 914. However, if transmission power which the gNB has indicated by a MAC-CE is enabled in the slot 913, the UE may drop CSI reporting because there is no CSI-RS received prior to the CSI reference resource 914.

Referring to FIG. 9, if transmission power which the gNB has indicated according to the above method is received in the slot 911 or 912 through DCI, the UE may report CSI by using this because there is a CSI-RS received prior to the CSI reference resource 914. However, if transmission power which the gNB has indicated is received in the slot 913, the UE may drop CSI reporting because there is no CSI-RS received prior to the CSI reference resource 914.

### Fourth Embodiment

In the fourth embodiment, a method for measuring and reporting CSI when the gNB adjusts beamforming at a shorter time interval, as described in the second embodiment, will be presented. This corresponds to a case in which the gNB indicates CSI MR as mentioned in the second embodiment. In other words, MR may be interpreted as an operation in which the gNB limits the UE's CSI measurement by using a specific CSI-RS resource with regard to a changed beam such that CSI can be reported more accurately to the gNB.

If the gNB does not indicate MR enabling, the UE may generally perform channel measurement by using a CSI-RS received prior to the CSI reference resource. It may be determined by UE implementation to what extent the UE will use the CSI-RS preceding the CSI reference resource. For example, a measurement window for the same may be used. Such a method may be identically applied when interference is measured by using a CSI-RS.

Unlike this, if the gNB adjusts MR at a short time interval through a MAC-CE or DCI as presented in the second embodiment, the UE may have to measure CSI, based on corresponding indication, and then report the same to the gNB. Therefore, there is a need to define a CSI measurement method in such a case. Specifically, the following alternatives may be considered. The disclosure is not limited to the following alternatives. It is to be noted that the following alternatives may be combined and used. In addition, a method wherein the following alternatives are all supported such that it is determined by an upper-level configuration which alternative will be used, may be considered. The upper-level configuration may be an RRC configuration.
Alternative 1: when the gNB indicates MR through a MAC-CE or DCI, the UE perform channel measurement by using only the latest single CSI-RS resource received from the gNB prior to the CSI reference resource. In addition, the UE performs interference measurement by using only the latest single CSI-RS or CSI-IM resource received prior to the CSI reference resource. In addition, the UE may generate CSI, based thereon, and report the same. According to alternative 1, the UE may expect that at least one CSI-RS for channel measurement and interference measurement for CSI reporting will be provided if MR has been indicated by a MAC-CE or DCI. This may mean that transmission of at least one CSI-RS for channel measurement and interference measurement is provided after the gNB indicates MR by a MAC-CE or DCI, and after the indication is enabled, and prior to the CSI reference resource. In addition, this may be accomplished by appropriate CSI-RS resource setting and CSI report setting configurations by the gNB.
Alternative 2: when indicating MR through a MAC-CE or DCI, the gNB provide the UE with at least one CSI-RS for channel measurement and interference measurement after the indication is enabled, and prior to the CSI reference resource.

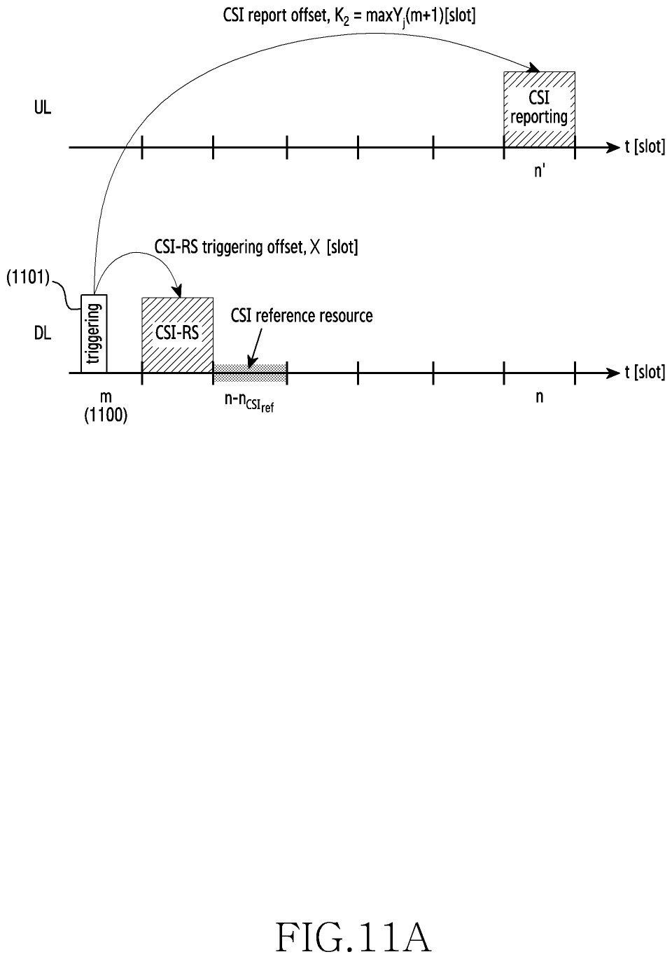

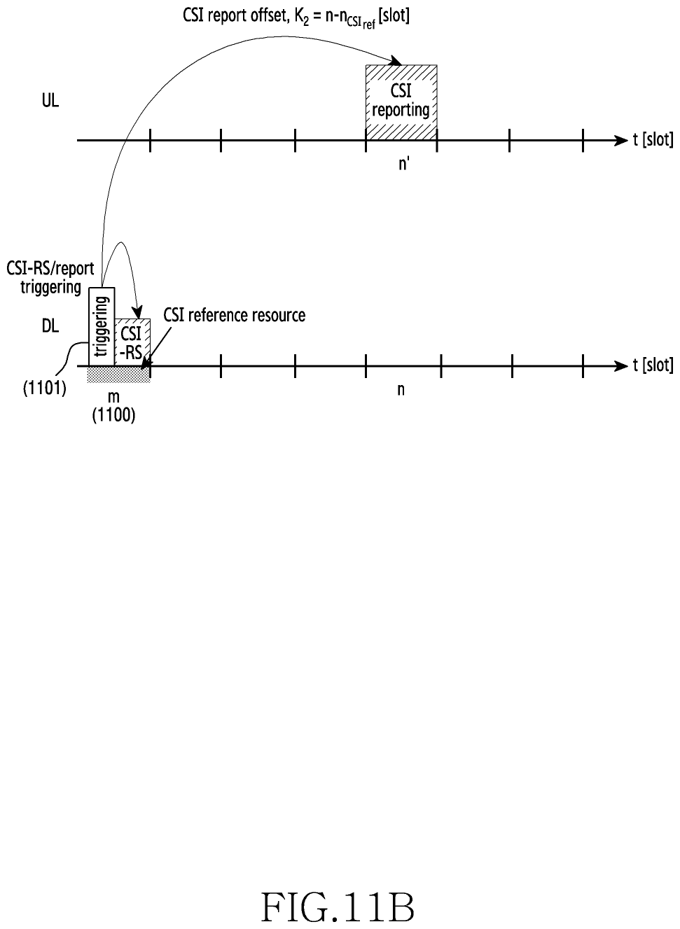

FIG. 11A and FIG. 11B illustrate a method wherein, when the gNB indicates MR according to alternative 2, transmission of at least one CSI-RS for channel measurement and interference measurement is provided after the indication is enabled, and prior to the CSI reference resource.

Referring to FIG. 11A and FIG. 11B, a case in which MR is enabled in slot m 1100 is illustrated. In FIG. 11A and FIG. 11B, reference numeral 1101 indicates a means for triggering MR and CSI-RS transmission and CSI reporting, and timepoint m 1100. This may be DCI 1101 through a PDCCH, or may be a MAC-CE 1101 through a PSSCH. Alternatively, the same may be a combination of the MAC-CE and DCI. In the case of the MAC-CE, reference numeral 1101 may correspond to a timepoint 913 at which the indication is enabled through the MAC-CE as described with reference to FIG. 10. As in FIG. 11A and FIG. 11B, MR and CSI-RS transmission and CSI reporting may be triggered at the same timepoint.

First, a method for indicating CSI reporting when the gNB indicates MR by a MAC-CE or DCI will be described with reference to FIG. 11A and FIG. 11B. The CSI reporting may be performed through a CSI setting configuration by the gNB. As a method, the interval K₂ between the slot 1101 in which CSI reporting is triggered and the UL slot in which CSI reporting is performed, as in FIG. 11A, may be expressed by the following equation:

$${K}_{2} = {max}_{j} {Y}_{j} ( m + 1 ) \qquad Equation 4$$

Yⱼ, j=0, . . . , N_{Rep}−1: the corresponding list entries of the allowed offset values for N_{Rep} triggered CSI reporting settings
Yⱼ(m+1): (m+1)th entry of Yⱼ

In a method different therefrom, the interval K₂ between the slot 1101 in which CSI reporting is triggered and the UL slot in which CSI reporting is performed, as in FIG. 11B, may be expressed by the following equation:

$${K}_{2} = {n}_{{CSI}_{r e f}} \qquad Equation 5$$

Equation 3 above is referred to for detailed description of n_{CSI}_{_{ref}}. Unlike the method according to Equation 4, Equation 5 may correspond to a method for receiving a CSI report from the UE more quickly when the gNB performs transmission parameter adjustment for energy saving at a short time interval.

Next, a method for performing CSI-RS transmission when the gNB indicates MR by a MAC-CE or DCI will be described with reference to FIG. 11A and FIG. 11B. CSI-RS transmission may be performed by a CSI-RS resource setting configuration by the gNB. As a method, the interval X (CSI-RS triggering offset) between the slot 1101 in which CSI reporting is triggered and the slot in which CSI-RS transmission is performed, as in FIG. 11A, is configured to precede the CSI reference resource slot. Equations 2 and 3 above are referred to for detailed description of the CSI reference resource slot. In a method different therefrom, a configuration is made such that X=0 as in FIG. 11B. In such a case, MR is enabled and the CRI-RS is transmitted in the same slot, which may be the CSI reference resource slot as in FIG. 11B. The method in FIG. 11B may be intended to receive a CSI report from the UE as quickly as possible when the gNB performs transmission parameter adjustment for energy saving at a short time interval.

### Fifth Embodiment

In the fifth embodiment, a detailed method in which the gNB indicates CSI measurement restriction (hereinafter, referred to as MR) will be presented. In the fifth embodiment, a case in which the gNB indicates MR by using method 1 (RRC signaling) in the second embodiment described above, and an additional case in which MR is indicated by a MAC-CE or DCI (methods 4 and 5 in the embodiment) are considered. The following two cases may thus be considered.
Case 1: MR indication through a MAC-CE or DCI is allowed only when MR is enabled by RRC.
Case 2: MR indication through a MAC-CE or DCI may be allowed regardless of whether MR is enabled by RRC or not.

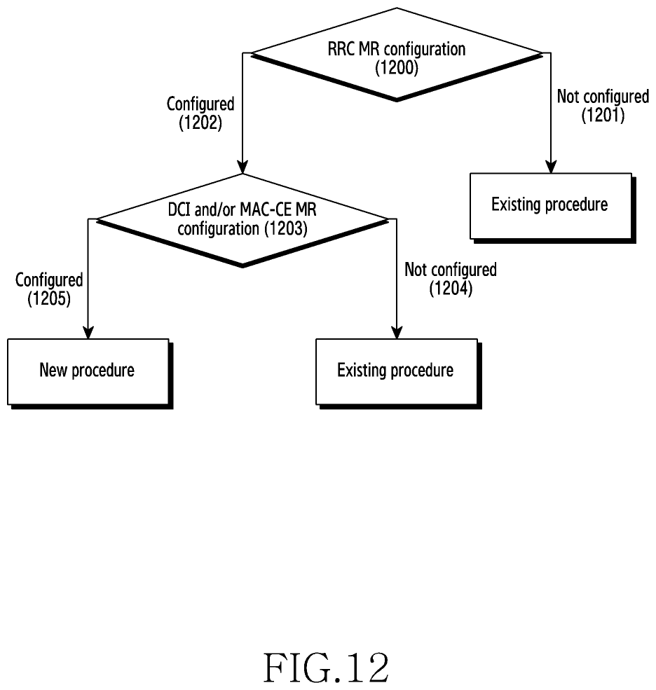

FIG. 12 is a diagram for describing the above-mentioned case 1 according to an embodiment of the disclosure.

Referring to FIG. 12, in step 1200, if MR is not enabled by RRC (1201), the UE may perform channel measurement by using a CSI-RS received prior to the CSI reference resource according to the existing procedure. It may be determined by UE implementation to what extent the UE will use the CSI-RS preceding the CSI reference resource. In addition, the UE may generate CSI, based thereon, and report the same to the gNB. If MR is enabled in step 1200, and if MR indication through a MAC-CE or DCI is not used in step 1203 (1204), the UE performs channel measurement by using only the latest single CSI-RS resource received from the gNB prior to the CSI reference resource according to the existing procedure. In addition, the UE performs interference measurement by using only the latest single CSI-RS or CSI-IM resource received prior to the CSI reference resource. In addition, the UE may generate CSI, based thereon, and report the same to the gNB. On the other hand, if MR is enabled in step 1200, and if MR indication through a MAC-CE or DCI is used in step 1203 (1205), the gNB and the UE may follow the procedure presented in the fourth embodiment described above.

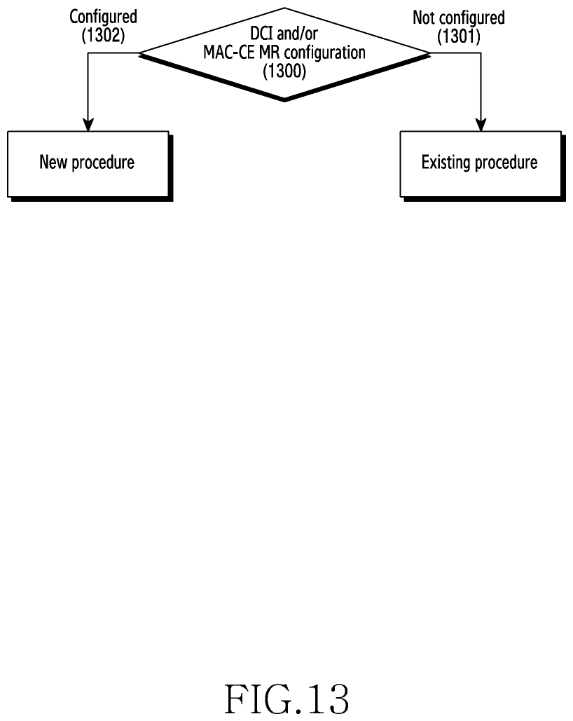

FIG. 13 is a diagram for describing the above-mentioned case 2 according to an embodiment of the disclosure.

Referring to FIG. 13, if MR indication through a MAC-CE or DCI is not used in step 1300 regardless of whether MR is enabled by RRC or not (1301), the UE performs channel measurement by using only the latest single CSI-RS resource received from the gNB prior to the CSI reference resource according to the existing procedure. In addition, the UE performs interference measurement by using only the latest single CSI-RS or CSI-IM resource received prior to the CSI reference resource. In addition, the UE may generate CSI, based thereon, and report the same to the gNB. On the other hand, if MR indication through a MAC-CE or DCI is used in step 1300 (1302), the gNB and the UE may follow the procedure presented in the fourth embodiment described above.

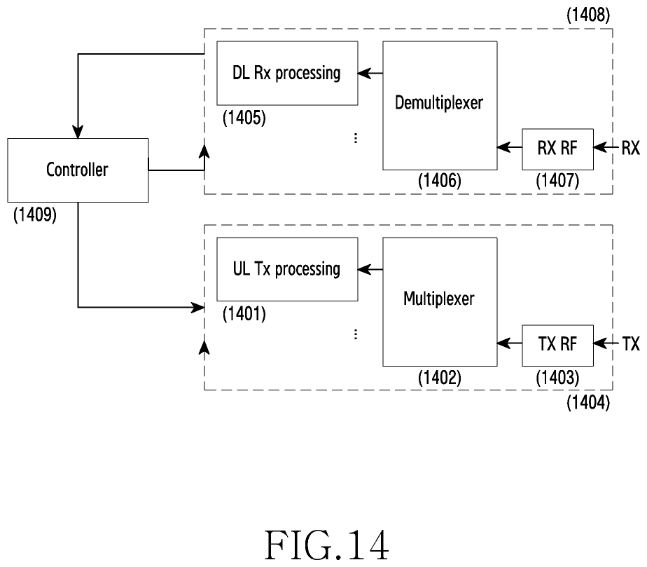

FIG. 14 illustrates a UE transmission/reception device in a wireless communication system according to an embodiment of the disclosure. For convenience of description, illustration and description of devices having no direct relevance to the disclosure may be omitted herein.

Referring to FIG. 14, the UE may include a transmitter 1404 including an uplink transmission processing block 1401, a multiplexer 1402, and a transmission RF block 1403, a receiver 1408 including a downlink reception processing block 1405, a demultiplexer 1406, and a reception RF block 1407, and a controller 1409. The controller 1409 may control respective constituent blocks of the receiver 1408 for receiving data channels or control channels transmitted by the gNB, as described above, and respective constituent blocks of the transmitter 1404 for transmitting uplink signals.

The uplink transmission processing block 1401 in the transmitter 1404 of the UE may generate signals to be transmitted, by performing processes such as channel coding and modulation. A signal generated by the uplink transmission processing block 1401 may be multiplexed with another uplink signal by the multiplexer 1402, signal-processed by the transmission RF block 1403, and then transmitted to the gNB.

The receiver 1408 of the UE demultiplexes signals received from the gNB and distributes the same to each downlink reception processing block. The downlink reception processing block 1405 may acquire control information or data transmitted by the gNB by performing processes such as demodulation and channel decoding with regard to downlink signals from the gNB. The receiver 1408 of the UE may apply the result of output from the downlink reception processing block to the controller 1409, thereby assisting operations of the controller 1409.

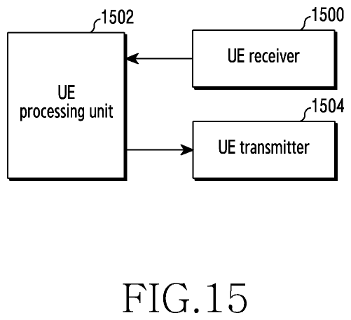

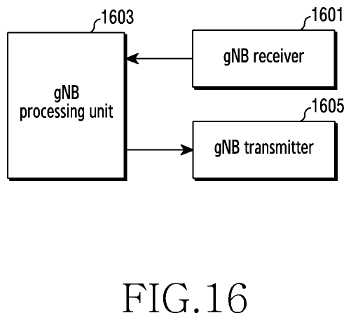

Transmitters, receivers, and processing units of the UE and the gNB for performing the above embodiments of the disclosure are illustrated in FIG. 15 and FIG. 16, respectively. The above embodiments provide a method in which the UE performs sidelink positioning, and the transmitters, receivers, and processing units of the UE and the gNB need to operate according to respective embodiments in order to perform the same.

Specifically, FIG. 15 illustrates an internal structure of a UE according to an embodiment of the disclosure. As illustrated in FIG. 15, the UE of the disclosure may include a UE receiver 1500, a UE transmitter 1504, and a UE processor 1502. In an embodiment of the disclosure, the UE receiver 1500 and the UE transmitter 1504 as a whole may be referred to as a transceiver. The transceiver may transmit/receive signals with the base station. The signals may include control information and data. To this end, the transceiver may include an RF transmitter configured to up-convert and amplify the frequency of transmitted signals, an RF receiver configured to low-noise-amplify received signals and down-convert the frequency thereof, and the like. In addition, the transceiver may receive signals through a radio channel, output the same to the UE processor 1502, and transmit signals output from the UE processor 1502 through the radio channel. The UE processor 1502 may control a series of processes such that the UE can operate according to the above-described embodiments of the disclosure.

FIG. 16 illustrates an internal structure of a base station according to an embodiment of the disclosure. As illustrated in FIG. 16, the base station of the disclosure may include a base station receiver 1601, a base station transmitter 1605, and a base station processor 1603. In an embodiment of the disclosure, the base station receiver 1601 and the base station transmitter 1605 as a whole may be referred to as a transceiver. The transceiver may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. In addition, the transceiver may receive signals through a radio channel, output the same to the base station processor 1603, and transmit signals output from the base station processor 1603 through the radio channel. The base station processor 1603 may control a series of processes such that the base station can operate according to the above-described embodiments of the disclosure.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented.

Also, the above respective embodiments may be employed in combination, as necessary. For example, all the embodiments of the disclosure may be partially combined with each other to operate a base station and a UE, and it will be obvious that combinations of all or a part of one embodiment and all or a part of one or more other embodiments also fall within the disclosure.

1. A method performed by a terminal of a wireless communication system, the method comprising:
receiving, from a base station, first information for dynamically changing ports or beams of a channel state information reference signal (CSI-RS);
receiving, from the base station, second information indicating a CSI-RS resource;
receiving a CSI-RS in the CSI-RS resource, based on the first information and the second information; and
transmitting, to the base station, channel state information (CSI) comprising a measurement result regarding the CSI-RS.

2. The method of claim 1, wherein the first information is received through a medium access control (MAC) control element (CE) or downlink control information (DCI), and
the first information is received in case that measurement restriction is preconfigured through radio resource control (RRC) signaling.

3. The method of claim 1, wherein the CSI-RS resource is the most recently received resource no later than a CSI reference resource, and the measurement result is generated only with regard to the CSI-RS received in the CSI-RS resource.

4. The method of claim 1, wherein the first information indicates that ports of the CSI-RS are reduced for network energy saving (NES).

5. A method performed by a base station of a wireless communication system, the method comprising:
transmitting, to a terminal, first information for dynamically changing ports or beams of a channel state information reference signal (CSI-RS);
transmitting, to the terminal, second information indicating a CSI-RS resource;
transmitting a CSI-RS in the CSI-RS resource, based on the first information and the second information; and
receiving, from the terminal, channel state information (CSI) comprising a measurement result regarding the CSI-RS.

6. The method of claim 5, wherein the first information is transmitted through a medium access control (MAC) control element (CE) or downlink control information (DCI), and
the first information is transmitted in case that measurement restriction is preconfigured through radio resource control (RRC) signaling.

7. The method of claim 5, wherein the CSI-RS resource is the most recently transmitted resource no later than a CSI reference resource, the measurement result is generated only with regard to the CSI-RS received in the CSI-RS resource, and
the first information indicates that ports of the CSI-RS are reduced for network energy saving (NES).

8. A terminal of a wireless communication system, the terminal comprising:
a transceiver; and
a controller connected to the transceiver,
wherein the controller is configured to:
receive, from a base station, first information for dynamically changing ports or beams of a channel state information reference signal (CSI-RS);
receive, from the base station, second information indicating a CSI-RS resource;
receive a CSI-RS in the CSI-RS resource, based on the first information and the second information; and
transmit, to the base station, channel state information (CSI) comprising a measurement result regarding the CSI-RS.

9. The terminal of claim 8, wherein the first information is received through a medium access control (MAC) control element (CE) or downlink control information (DCI), and
the first information is received in case that measurement restriction is preconfigured through radio resource control (RRC) signaling.

10. The terminal of claim 8, wherein the CSI-RS resource is the most recently received resource no later than a CSI reference resource, and the measurement result is generated only with regard to the CSI-RS received in the CSI-RS resource.

11. The terminal of claim 8, wherein the first information indicates that ports of the CSI-RS are reduced for network energy saving (NES).

12. A base station of a wireless communication system, the base station comprising:
a transceiver; and
a controller connected to the transceiver,
wherein the controller is configured to:
transmit, to a terminal, first information for dynamically changing ports or beams of a channel state information reference signal (CSI-RS);
transmit, to the terminal, second information indicating a CSI-RS resource;
transmit a CSI-RS in the CSI-RS resource, based on the first information and the second information; and
receive, from the terminal, channel state information (CSI) comprising a measurement result regarding the CSI-RS.

13. The base station of claim 12, wherein the first information is transmitted through a medium access control (MAC) control element (CE) or downlink control information (DCI), and
the first information is transmitted in case that measurement restriction is preconfigured through radio resource control (RRC) signaling.

14. The base station of claim 12, wherein the CSI-RS resource is the most recently transmitted resource no later than a CSI reference resource, and the measurement result is generated only with regard to the CSI-RS received in the CSI-RS resource.

15. The base station of claim 12, wherein the first information indicates that ports of the CSI-RS are reduced for network energy saving (NES).
